(19) United States
(12) Patent Application Publication
(10) Pub. No.: US 2024/0370072 A1
(43) Pub. Date: Nov. 7, 2024

(54) Seaborne System for Mitigating Offshore Natural Gas Flaring

(71) Applicant: Crusoe Energy Systems LLC, Denver, CO (US)

(72) Inventors: Charles Cavness, Denver, CO (US); Kenneth Parker, Denver, CO (US); Stephen Horn, Castle Rock, CO (US); Jeff Balkanski, San Francisco, CA (US); Anna Landler, San Francisco, CA (US)

(21) Appl. No.: 18/605,808

(22) Filed: Mar. 14, 2024

Related U.S. Application Data
(60) Provisional application No. 63/452,015, filed on Mar. 14, 2023.

(51) Int. Cl. G06F 1/26

(52) U.S. Cl. CPC G06F 1/266

(57) ABSTRACT

A method of powering distributed computing units by a fuel gas stream originating from an underwater oil well below the ocean includes transporting, by at least one floating vessel, a power production system, a communications system and a power consumption system to an offshore drilling platform, the offshore drilling platform including a pipeline transporting natural gas originating from the underwater oil well; receiving, by the power production system, a fuel gas stream from the pipeline comprising a fuel gas; generating, by the power production system, from the fuel gas, an electrical output; and powering, by the power production system, via the electrical output, a plurality of distributed computing units of a power consumption system.

### CROSS-REFERENCE TO RELATED APPLICATIONS

The present application claims benefit of U.S. provisional patent application No. 63/452,015, titled “Seaborne System for Mitigating Offshore Natural Gas Flaring,” filed Mar. 14, 2023 and U.S. provisional patent application No. 63/553,619, titled “System and Method for Dynamic Balancing of Power Production and Consumption,” filed Feb. 14, 2024, both of which are incorporated by reference herein in their entireties.

### BACKGROUND

Offshore oil platforms represent some of the most long-term and large-scale stranded natural gas situations in the world. Many offshore oil discoveries are located in the territorial waters of small or developing countries, where no domestic natural gas market exists. As a result, natural gas is flared until projects costing tens of billions of dollars can be developed, financed, permitted, and constructed. These projects, such as liquefied natural gas (“LNG”) export terminals or international pipelines, may take decades to consummate and in many cases never materialize due to complexity and economic uncertainty. The scale of offshore discoveries and oil production volumes are often immense, and so too are the associated gas volumes being flared. To date, no viable solution exists for offshore gas capture and utilization short of major permanent infrastructure.

One potential solution to the natural gas problem lies in distributed computing. Cryptocurrency is a booming asset class with the combined market capitalization of digital currencies surpassing $2 Trillion in 2021. Many cryptocurrencies operate on a distributed system of computers “mining” the currencies—essentially processing the underlying algorithms to continuously verify transactions and account balances. The crypto mining process is a significant industry in its own right, projected to reach a value of $39 billion by 2025 with a projected CAGR of 29.7%.

This high-growth industry requires innovative and inexpensive electricity sources as it requires enormous amounts of power—approximately 29 TWh of electricity per year on a global basis. Indeed, electricity is typically the single largest lifetime cost to a cryptocurrency mining operation, with power costs offsetting approximately 30% of total mining revenues in the US.

Accordingly, there remains a need for systems and methods for the beneficial use of natural gas produced from offshore oil platforms. It would be valuable if electricity could be produced and consumed on-site, for example, by using it to operate power-intensive, modular processing units. It would be further beneficial if such processing units could be employed to mine cryptocurrency or perform other distributed computing tasks to generate additional revenue.

### SUMMARY

An offshore flare mitigation system for powering distributed computing units by a fuel gas stream originating from an underwater oil well below the ocean is provided. The system includes at least one floating vessel adapted for floating in the ocean; a power production system including: a power generation module adapted to: receive the fuel gas stream including a fuel gas associated with a heat value of at least about 1,000 Btu/scf; and consume the fuel gas stream to generate a high-voltage electrical output associated with a first voltage; and an electrical transformation module in electrical communication with the power generation module, the electrical transformation module adapted to: receive the high-voltage electrical output generated by the power generation module; and transform the high-voltage electrical output into a low-voltage electrical output associated with a second voltage that is lower than the first voltage; a communications system including one or more data satellite antennas, the communications system adapted to provide a network; and a power consumption system powered by the power production system, the power consumption system including: a data center including: an enclosure defining an interior space; a plurality of the distributed computing units located within the interior space of the enclosure, each of the plurality of distributed computing units in communication with the network; and a power system located at least partially within the interior space of the enclosure, the power system in electrical communication with the electrical transformation module and the plurality of distributed computing units such that the power system receives the low-voltage electrical output and powers each of the plurality of distributed computing units, the at least one floating vessel carrying the power production system, the communications system and the distributed computing system.

In examples, the at least one vessel is a single vessel carrying the power production system, the communications system and the power consumption system.

In examples, the at least one vessel includes a powership carrying the power production system and a data-processing vessel carrying the communications system and the power consumption system.

In examples, the vessel includes a heat transfer system configured for pumping ocean water through heat transfer tubes.

In examples, the heat transfer system includes dielectric fluid for transferring heat from the distributed computing units to the ocean water pumped through the heat transfer tubes.

In examples, the offshore flare mitigation system further includes a control system for dynamic control of power consumption of the distributed computing units, the system including: a processor; a memory; and a power control module and container orchestrator stored in the memory that, when executed by the processor, causes the processor to perform operations including: (a) receive metrics of the power production system and metrics of power consumption system; (b) determine a target power production framework that includes a target power delta for each device associated with the power production system, the target power deltas being based on the metrics of power production system; (c) determine an optimal power consumption distribution model for distributing the target power deltas of the target power production framework to the power consumers based on the target power production framework and the metrics of power consumption system; (d) output signals for altering a power state (or workmode) of the power consumers to achieve the optimal power consumption distribution model; and (e) periodically repeat (a) to (d) to update the power state of the power consumers based on changes of the metrics of the power production system and changes of metrics of the power consumption system

A method of powering distributed computing units by a fuel gas stream originating from an underwater oil well below the ocean is also provided. The method includes transporting, by at least one floating vessel, a power production system, a communications system and a power consumption system to an offshore drilling platform, the offshore drilling platform including a pipeline transporting natural gas originating from the underwater oil well; receiving, by the power production system, a fuel gas stream from the pipeline including a fuel gas having a heat value of at least about 1,000 Btu/scf; generating, by the power production system, from the fuel gas, a high-voltage electrical output associated with a first voltage; transforming, by the electrical power generation system, the high-voltage electrical output into a low-voltage electrical output associated with a second voltage that is lower than the first voltage; and powering, by the power production system, via the low-voltage electrical output, a plurality of distributed computing units of the power consumption system.

In examples, the method further includes (a) measuring and/or receiving metrics of the power production system and metrics of power consumption system; (b) determining a target power production framework that includes a target power delta for each device associated with the power production system, the target power deltas being based on the metrics of power production system; (c) determining an optimal power consumption distribution model for distributing the target power deltas of the target power production framework to the power consumers based on the target power production framework and the metrics of power consumption system; (d) altering a power state (or workmode) of the power consumers to achieve the optimal power consumption distribution model; and periodically repeating (a) to (d) to update the power state of the power consumers based on changes of the metrics of the power production system and changes of metrics of the power consumption system.

A method is also provided for powering a power consumption system onboard a vessel at an offshore drilling site, the power consumption system including a plurality of distributed computing units, the method including: powering the distributed computing units by one or more power generation modules consuming natural gas originating from the offsite drilling site and continuously generating an electrical output; while an alternative energy source powers a battery bank; and determining that the one or more power generation modules are incapable of generating sufficient power for powering the distributed computing units and powering the distributed computing units at least in part by the alternative energy source and/or the battery bank.

In examples, the method further includes determining that the one or more power generation modules are producing excess power than the distributed computing units can consumer, and directing the excess power to charge the battery bank.

### BRIEF DESCRIPTION OF THE DRAWINGS

The details of one or more embodiments of the subject matter of this specification are set forth in the accompanying drawings and the description below. Other features, aspects, and advantages of the subject matter will become apparent from the description, the drawings, and the claims.

FIG. 1A schematically shows components of an exemplary offshore flare mitigation system 100 according to an embodiment including a power consumption system 103 and a power production system 200.

FIGS. 1B and 1C show exemplary seaborne system components deployed via one or more vessels.

FIG. 2 schematically shows an example of the power production system 200 that may be utilized in the system 100 of FIG. 1A.

FIG. 3A illustrates a power control method 1300 of dynamically controlling a supply of power in the system of FIG. 1A.

FIG. 3B illustrates substeps of step 306 of the method of FIG. 3A.

FIG. 4 schematically shows a simplified power consumption distribution model 400 and helps to illustrate the substeps of step 306 of the method of FIG. 3A.

FIG. 5 shows an exemplary distributed computing system 500 according to an embodiment.

FIG. 6 shows an exemplary immersion cooling system according to an embodiment.

FIG. 7A shows shell-and-tube heat exchangers according to an embodiment.

FIG. 7B shows plate-type heat exchangers according to an embodiment.

FIG. 7C shows radiative piping according to an embodiment.

FIG. 8 shows an exemplary natural gas processing system according to an embodiment.

FIG. 9 shows an exemplary power management system 900.

FIG. 10 shows the power management system 900 in a first condition.

FIG. 11 shows power management system 900 in second condition.

FIG. 12 shows power management system 900 in a third condition.

### DETAILED DESCRIPTION

In accordance with the foregoing objectives and others, exemplary seaborne systems are provided herein to generate electricity from natural gas produced via offshore oil platforms. Such seaborne systems may utilize the generated electricity to power any number of modular distributed computing units. In certain embodiments, the distributed computing units may be adapted to mine cryptocurrency or perform other distributed computing tasks to generate revenue.

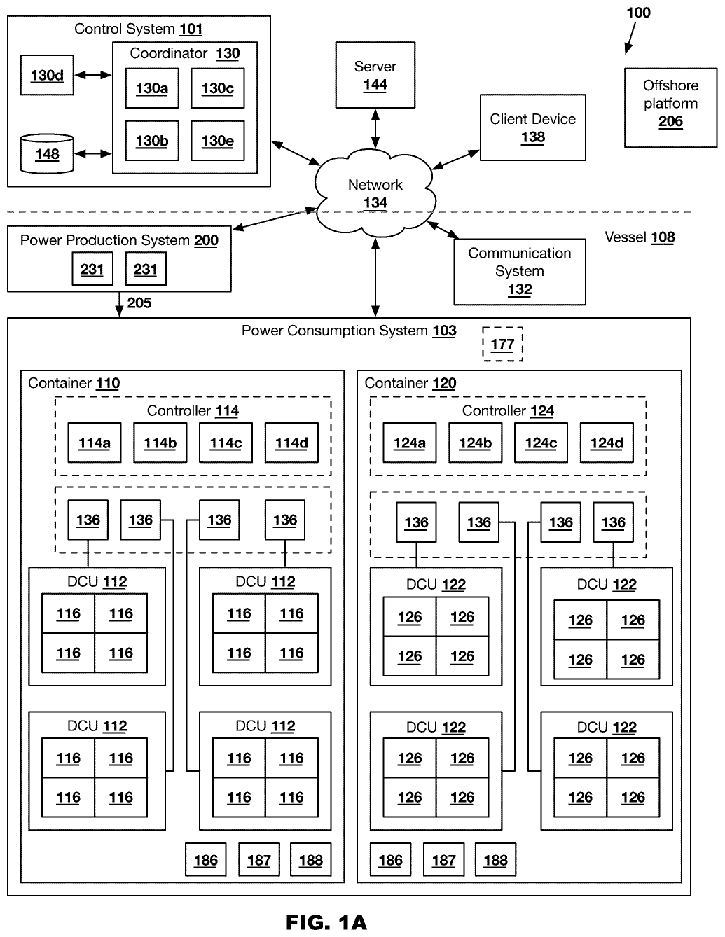

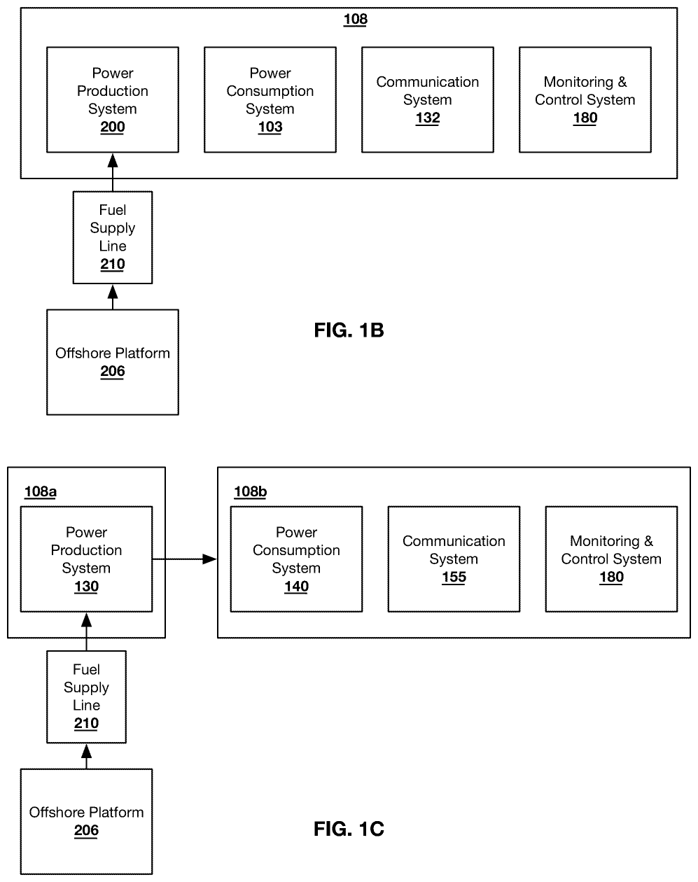

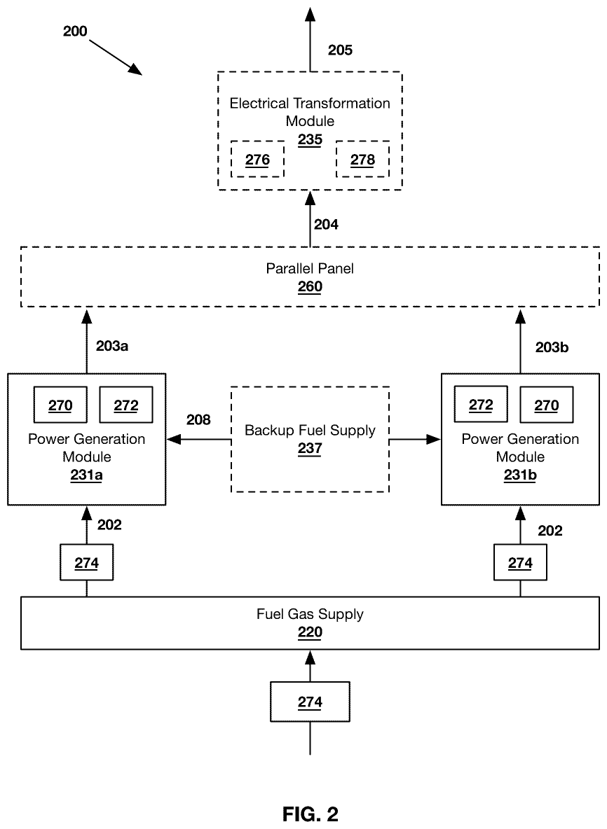

FIG. 1A schematically shows components of an exemplary offshore flare mitigation system 100 for dynamic control of power consumption of computer resources. As shown, the system 100 includes a central control system 101 in communication, via a network 134, with various subsystems that are installed on one or more offshore floating vessels 108 adapted for floating in the ocean at an offshore drilling site. Generally, one or more offshore vessels 108 carry a power production system 200, a power consumption system 103, which includes a plurality of distributed computing units (DCUs) 112, 122, and a communication system 132 to provide communication with the control system 101 (e.g., via a network 134). FIG. 2 schematically shows an exemplary power production system 200 that may be utilized in the system 100 of FIG. 1A.

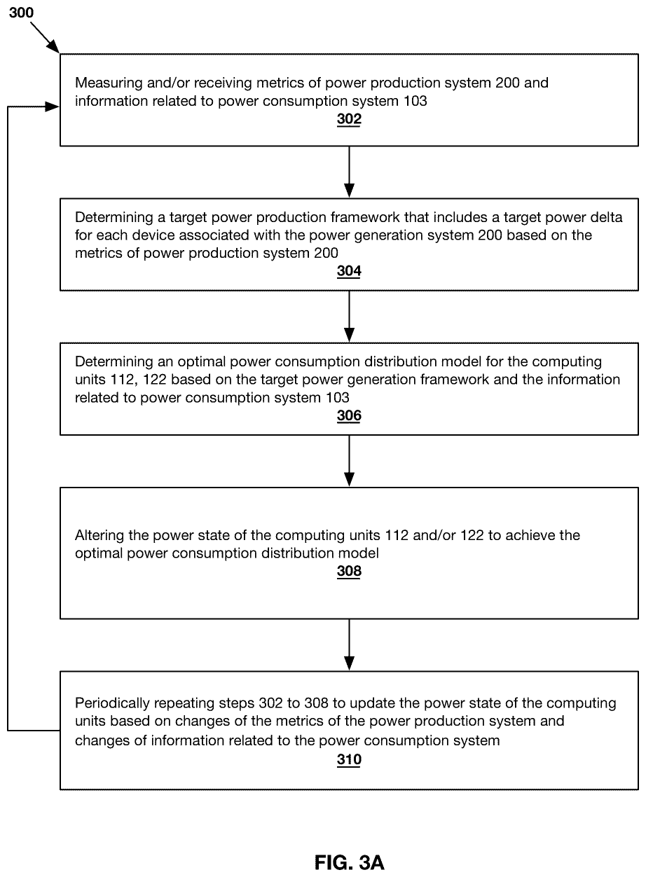

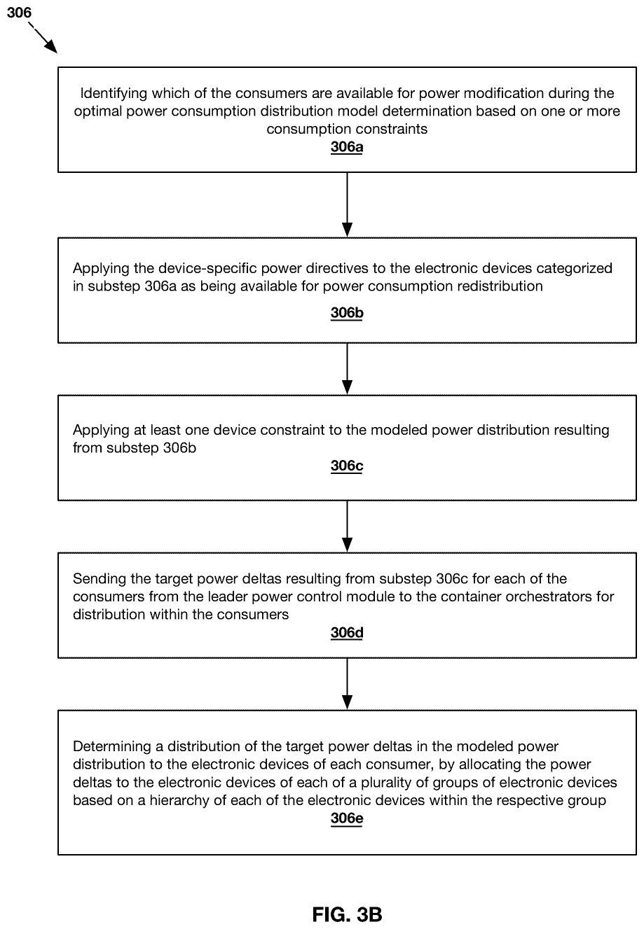

A method 300 of the present disclosure advantageously controls a power consumption of computing units 112, 122 of the power consumption system 103 powered by the power production system 200. As shown in FIG. 3a and discussed further below, the method includes a step 302 of measuring and/or receiving metrics of power production system 200 and metrics related to power consumption system 103; a step 304 of determining a target power production framework that includes a target power delta for each device associated with the power production system 200 based on the metrics of power production system 200; and a step 306 of determining an optimal power consumption distribution model for distributing the target power deltas of the target power production framework to the computing units 112, 122 based on the target power production framework and the metrics related to power consumption system 103. The optimal power consumption distribution model can include a power directive for each of the devices of the power generation system 200 to be applied to the group of computing units 112 and/or the group of computing units 122. The optimal power consumption distribution model can include at least one constraint of at least one of the devices associated with the power production system 200. The method 300 further includes a step 308 of altering the power state of the computing units 112 and/or 122 to achieve the optimal power consumption distribution model; and then a step 310 of periodically repeating steps 302 to 308 to update the power state of the computing units based on changes of the metrics of the power production system and changes of metrics related to the power consumption system 103. By periodically determining a target power delta for each device, using these target power delta to determine an optimal power consumption distribution model and the altering the power state of the power consumers to achieve a power consumption distribution of optimal power consumption distribution model, the method 300 prevents shutdowns of and/or damage to the power consumers while maximizing revenue-generating activity by DCUs 112, 122.

Referring back to FIG. 1A, the central control system 101 is generally configured to manage (i.e., model, monitor and control) the components on the one or more offshore vessels 108 in order to maintain processing conditions within acceptable operational constraints. Such constraints may be determined by economic, practical, and/or safety requirements. In certain embodiments, a coordinator 130 of the control system 101 may handle high-level operational control goals, low-level PID loops, communication with both local and remote operators, and communication with both local and remote systems.

In one embodiment, the coordinator 130 comprises a coordinator processor 130a, a coordinator memory 130b and a system orchestrator 130c stored in the coordinator memory 130b and executable by the coordinator processor 130a to cause the coordinator processor 130a to perform operations related to managing the various components associated with each offshore site. Although only a single vessel 108 at a single offshore site is illustrated, it will be appreciated that the control system 101 may manage any number of vessels at any number of offshore sites and/or additional components that are not associated with a particular offshore site.

As shown in FIG. 1A, the one or more vessels 108 at each offshore site may comprise or communicate with a communication system 132, which can be a device that connects the power consumers of the power consumption system 103 to a satellite or an optical fiber, that provides a network 134 to which various components of the system 100 may be connected. The network 134 may include wide area networks (“WAN”), local area networks (“LAN”), intranets, the Internet, wireless access networks, wired networks, mobile networks, telephone networks, optical networks, or combinations thereof. The network 134 may be packet switched, circuit switched, of any topology, and may use any communication protocol. Communication links within the network 134 may involve various digital or analog communication media such as fiber optic cables, free-space optics, waveguides, electrical conductors, wireless links, antennas, radio-frequency communications, and so forth. In one embodiment, the communication system 132 may provide an internal network for a given offshore site.

As shown, the system 100 includes a power production system 200 on the one or more vessels 108. The power production system 200 may include any number of power producers 231 adapted to generate electrical power 205 that may be consumed by the power consumers of the power consumption system 103. As discussed in detail below with respect to FIG. 2, the power producers 231 may comprise one or more power generation modules (e.g., gensets, turbines, etc.) that generate electrical power 205 from a fuel gas (e.g., natural gas, propane, diesel, etc.). Additionally or alternatively, energy producers such as solar panels, wind turbines, batteries, etc. may be employed.

A power consumption system 103 is also provided on the one or more vessels 108. The power consumption system 103 generally comprises any number of power consumers, which can be DCUs 112, 122, adapted to consume the electrical power 205 generated by the power production system 200. Preferably, the DCUs 112, 122 collectively enable a modular computing installation, for example, a data center, cryptocurrency mine or graphics computing cell.

Each of the DCUs 112, 122 may comprise a computing machine having one or more processors 116, 126 (e.g., CPUs, GPUs, ASICs, etc.) adapted to conduct any number of processing-, computational-, and/or graphics-intensive computing processes. For example, the DCUs may be employed for artificial intelligence (“AI”) research, training machine learning (“ML”) and other models, data analysis, server functions, storage, virtual reality (“VR”) and/or augmented reality (“AR”) applications, tasks relating to the Golem Project, non-currency blockchain applications.

As another example, the DCUs may be employed to execute mathematical operations in relation to the mining of cryptocurrencies, such as the following hashing algorithms: SHA-256, ETHash, scrypt, CryptoNight, RIPEMD160, BLAKE256, X11, Dagger-Hashimoto, Equihash, LBRY, X13, NXT, Lyra2RE, Qubit, Skein, Groestl, BOINC, X11gost, Scrypt-jane, Quark, Keccak, Scrypt-OG, X14, Axiom, Momentum, SHA-512, Yescrypt, Scrypt-N, Cunningham, NIST5, Fresh, AES, 2Skein, Equilhash, KSHAKE320, Sidechain, Lyra2RE, HybridScryptHash256, Momentum, HEFTY1, Skein-SHA2, Qubit, SpreadX11, Pluck, and/or Fugue256.

As shown, the DCUs 112, 122 may be housed within one or more containers, structures, or data centers 110, 120 disposed one the one or more vessels 108 at the offshore site. In some embodiments, the containers 110, 120 may comprise a prefabricated housing or enclosure to contain and protect the various electronics disposed therein. The enclosure may define an interior space for the DCUs 112, 122 and controllers 114, 124 and may comprise a customized shipping container or other modular housing system designed for portability, durability, safety, stack-ability, ventilation, weatherproofing, dust control and operation in rugged oilfield conditions.

Each container 110, 120 may also include an electrical power distribution system 186 adapted to receive electrical power 205 from the power production system 200 and distribute the same to the various electrical components of the container. To that end, the power distribution system 186 may comprise a series of power distribution units (“PDUs”) or power channels in communication with one or more breaker panels. In some embodiments the containers 110, 120 may include one or more backup power systems 187 (e.g., batteries, additional generators, etc.), and/or an environment control system 188.

In some examples, the power consumers can include other power consumers inside of the containers 110, 120, including oil production equipment at the offshore site including, for example, pumps, lighting equipment, computer networking equipment and control systems.

In other examples, power consumers can include power consumers outside of the containers 110, 120, including oil production equipment at the offshore site including, for example, pumps, lighting equipment, computer networking equipment and control systems.

As shown, the containers 110, 120 (and any electronic components contained therein) are in communication with the central control system 101 via a connection to the communication system 132. For example, each container 110, 120 may include a plurality of network interfaces 136 of communication system 132 (each having a network address) and the DCUs 112, 122 may be connected to such interfaces 136 (e.g., via ethernet).

Each container 110, 120 may comprise a container controller 114, 124 configured to communicate with the central control system 101 and the DCUs of the respective container (discussed below). For example, a first container 110 may include a plurality of first DCUs 112 and a first container controller 114 configured for controlling the first DCUs 112. And a second container 120 may include a plurality of second DCUs 122 and a second container controller 124 configured for controlling the second DCUs 122. In each case, the respective container controller 114, 124 may control one or more associated DCUs 112, 122 based on metrics received from the DCUs (or other container components) and/or according to instructions received from the central control system 101.

As shown, each container controller 114, 124 may include a controller processor 114a, 124a, a controller memory 114b, 124b, and a container orchestrator 114c, 124c. Each container controller 114, 124 is generally configured to determine consumer metrics for each power consumer associated with the respective container and container metrics corresponding to the respective container (discussed in detail below). The container controller 114, 124 may further be configured to store such metrics in the respective controller memory 114b, 124b.

Each container controller 114, 124 may include a control module 114d, 124d adapted to adjust operating parameters of associated power consumers (e.g., DCUs 112, 122). As detailed below with respect to FIG. 3, the container controllers 114, 124 may employ the control modules 114d, 124d to determine an optimal power consumption distribution model to balance a load of the container(s) to a target power received from the control system 101 (either directly or via an intermediary such as a power consumption system controller 177). The control module 114d, 124d may then output the optimal power consumption distribution model for adjusting a power state of one or more power consumers in order to balance the power consumers' power consumption based on the target power production. Moreover, the control module may select DCUs and/or particular DCU processors (e.g., 116, 126) for such adjustment, based on consumer metrics associated with each of the power consumers; to satisfy predetermined requirements or constraints; and/or to optimize a total utility of the power consumers (e.g., revenue generation, hash power, uptime, etc.).

For each offshore site, a single power control module (e.g., power control module 114d) can be elected as a leader to perform the power control determinations that are used to increase or decrease the power of one or more of DCUs 112, 122 or other the power consumers.

The leader can be chosen by the central coordinator 130, which informs the leader which devices of power production system 200 and power consumers of power consumption system 103 to fetch metrics from, and which devices are associated with each power consumer. Coordinator 130 can send a request to all container controllers 114, 124 (i.e. locations) at predefined time intervals (e.g., every 60 seconds), and keeps track of the last ping for each of power control module 114d, 124d. In one embodiment, coordinator 130 sends a request ping to all current power control module leaders at predefined time intervals, (e.g., every 1 to 30 seconds). If a leader is unresponsive for more than a predefined time intervals, e.g., 20 to 300 second, or at least 2 pins, e.g., 2 to 10 request pings, such unresponsiveness triggers a leader re-election. For the leader re-election, the container controller 114, 124 with the most recent ping time is elected as new leader, and the new leader is notified via a leader notification. In some embodiments, the leader notification can be an API call.

Each offshore site can include a plurality of containers (e.g., two or more of containers 110, 120), each including a container controller 114, 124, interfaces 136 and DCUs. The container controllers and DCUs of each offshore site can be connected via a single local area network (LAN) that is in communication with network 134. For each LAN, a single power control module 114d can determine an optimal power consumption distribution model for distributing target power deltas to all of DCUs 112, 122 on the LAN so that the leader power control module 114d distributes power consumption instructions to a plurality of container orchestrators 114c, 124c. This single power control module can be deemed the leader. In other embodiments, a separate LAN can be provided for each container—i.e., each container controller and DCUs of the corresponding container can be connected to a respective LAN, and a single power control module 114d can determine an optimal power consumption distribution model for distributing target power deltas to all of DCUs 112, 122 on multiple LANs so that the leader power control module 114d distributes power consumption instructions to a plurality of container orchestrators 114c, 124c each on a respective LAN.

For example, as further explained below with respect to FIG. 3, the DCUs 112 of container can be grouped into one or more consumer objects and the DCUs 112 of container can be grouped into one or more consumer objects, and the leader power control module 114d can determine an optimal power consumption distribution model for each consumer object and instructs container orchestrators 114c, 124c to increase or decrease the power consumption of each consumer object on a consumer object-by-consumer object basis according to the optimal power consumption distribution model. The respective container orchestrator 114c, 124c then determines how the increase or decrease of the power consumption is allocated to the DCUs within each consumer object.

As discussed further below with respect to the method of FIG. 3, controller 114 and/or 124 can provide a control system for dynamic power consumption control of the power consumers, e.g., DCUs 112 and/or 124, of power consumption system 103. The control system comprises a processor 114a and/or 124a, a memory 114b and/or 124b, and a power control module 114d and/or 124d and container orchestrator 114c and/or 124c. The leader power control module 114d and the container orchestrator 114c and/or 124c are stored in the respective memory 114b, 124b that, when executed by the respective processor 114a, 124a, causes the processor 114a, 124a to perform, as part of step 302 of method 300, (a) receive metrics of the power production system 200 and metrics related to power consumption system 103; (b) as part of step 304 of method 300, determine a target power production framework that includes a target power delta for each device associated with the power production system 200, with the target power deltas being based on the metrics of power production system; (c) as part of step 306 of method 300, determine an optimal power consumption distribution model for distributing the target power deltas of the target power production framework to the consumer objects based on the target power production framework and the metrics related to power consumption system 103; (d) as part of step 308 of method 300, output signals for altering a power state of the power consumers to achieve the optimal power consumption distribution model; and, as part of step 310 of method 300, periodically repeating (a) to (d) to update the power state of the power consumers based on changes of the metrics of the power production system 200 and changes of metrics related to the power consumption system 103.

As part of substep 302 of method 300, the leader power control module 114d, when executed by the processor 114a, can cause the processor 114a to, as part of the step (a), fetch real time metrics for each of the devices of power production system 200 and for each of the consumer objects. The leader power control module 114d can fetch data originating from the sensors of power production system 200, e.g., from sensors 270, 274, 276, on a offshore site and from the orchestrators 114c, 124c, combining all metric from power production and consumption. The metrics can be fetched at predetermined internals, such as every 1 to 60 seconds. The metrics for each of the consumer objects of power consumption system 103 fetched from orchestrators 114c, 124d can include a current power, a minimum power, a maximum power and a utility value for each consumer object.

As part of substep 304 of method 300, the power control module 114d and/or 124d, when executed by the processor 114a and/124a, can cause the processor 114a and/or 124a to, as part of the step (b), calculate a target power delta for each of the metrics; for each of the devices of power production system 200 for which more than one target power delta is calculated, select a minimum target power delta from amongst the target power deltas for the device as the selected target power delta for the device; and for each of the devices of power production system 200 for which only a single target power delta is calculated, selecting the single target power delta as the selected target power delta for the device.

As part of substep 306 of method 300, the power control module 114d and/or 124d, when executed by the processor 114a and/or 124a, can also cause the processor 114a and/or 124a to, as part of the step (c), apply the selected target power delta for at least one of the devices of power production system 200 as a power directive in a modeled power consumption distribution to the power consumers associated with the respective device, with each of the consumer objects representing a group of the DCUs 112 and/or 124 or other the power consumers.

As part of substep 306 of method 300, the power control module 114d, when executed by the processor 114a, can also cause the processor 114a to, as part of the step (c), limit the target power production framework by applying at least one constraint of at least one of the devices to the consumer objects to determine the optimal power consumption distribution model.

As part of substep 306 of method 300, the container orchestrator 114c and/or 124c, when executed by the processor 114a and/or 124a, can also cause the processor 114a and/or 124a to, after the application of the power directive and the applying of the at least one constraint, determine a distribution of the target power deltas in the modeled power distribution to DCUs 112 and/or 124 or other the power consumers on a consumer object-by-consumer object basis by determining an allocation of the power deltas to DCUs 112 and/or 124 or other the power consumers within each consumer object based on a hierarchy of each of DCUs 112 and/or 124 or other the power consumers within the respective consumer object; and determine and allocation of a power delta distributed by the modeled power distribution to the DCUs 112 and/or 124 or other power consumers of each consumer object based on the hierarchy of each consumer. The hierarchy ordering the DCUs 112 and/or 124 or other the power consumers of each consumer object based on a specified utility of each of the DCUs 112 and/or 124 or other the power consumers within the respective consumer object. As discussed further below, the specified utility can be a monetary value of operating DCUs 112 and/or 124 or other the power consumers in comparison to power consumption.

As part of substep 306 of method 300, the container orchestrator 114c and/or 124c, when executed by the processor 114a and/124a, can also cause the processor 114a and/124a to alter the power state of the DCUs 112 and/or 124 or other the power consumers to achieve the optimal power consumption distribution model.

### Vessels

Examples of the one or more vessels 108 is further described with respect to FIGS. 1B-1C.

As shown in FIGS. 1B-1C, the various components of the system 100 may be disposed in/on one or more vessels. For example, FIG. 1B shows the power production system 200, power consumption system 103, communication system 132, and a monitoring and control system 180 located at a single vessel 108 in communication with an offshore platform 206.

As another example, FIG. 1C shows the power production system 200 located on a vessel in the form of a separate powership 108a that is in communication with an offshore platform 206. As shown, the power consumption system 103, communication system 132, and monitoring and control system 180 may be located at a data-processing vessel 108b, which is in communication with the powership 108a. Monitoring and control system 180 can represent power consumption system controller 177, sensors 270, 274, 276, and controllers 272, 278. In such embodiment, the powership 108a may receive natural gas from the offshore platform to generate electrical power therefrom and may transmit the electrical power to the various components of the data-processing vessel 108b.

It will be appreciated that vessel(s) of various sizes may be employed as desired or required (e.g., based on the amount of natural gas available at the offshore platform). Generally, a single vessel 108 or powership 108a may comprise a length of from about 150 feet to about 1,000 feet and a width of from about 50 feet to about 150 feet. Specific examples may include vessels having:
a maximum capacity of about 40 MW, a length of about 84 meters, and a width of about 18 meters;
a maximum capacity of about 80 MW, a length of about 90 meters, and a width of about 25 meters;
a maximum capacity of about 240 MW, a length of about 140 meters, and a width of about 42 meters; and
a maximum capacity of about 500 MW, a length of about 300 meters, and a width of about 50 meters.

The vessel(s) may or may not be self-propelled. Moreover, the vessel(s) may comprise one or more of an on-board high-voltage substation, on-board fuel storage, and on-board accommodations.

In one embodiment, one or more system components may be located on a deck of the vessel. In another embodiment, one or more system components may be located within a hull of the vessel. In yet another embodiment, one or more system components may be external to the vessel (e.g., a submersible mobile data center in communication with a vessel).

### Fuel Supply

Returning to FIG. 1A, a safety-optimized fuel supply line 207 may be provided to bring natural gas 210 from an offshore platform 206, across a span of air or open ocean water, and ultimately into fuel supply lines feeding an power production system 200 onboard a vessel.

Generally, the fuel supply line 207 comprises a conduit that is flexible enough to move with sea conditions including swells, drift, storms or other causes of changing distance between the offshore platform and the vessel carrying the power production system 200. The fuel supply line 207 is also strong enough to tolerate high gas pressures and various stresses and strains exerted by the environment.

In one embodiment, the fuel supply line 207 may comprise a corrugated metal liner surrounded by a rubberized coating. The fuel supply line may comprise materials selected to withstand gas pressure of up to about 1,500 psi and to withstand the expected stress/strain of one or more moving ends of the line. In one embodiment, the fuel supply line 207 may comprise a length of from about 100 feet to about 1,000 feet.

The fuel supply line 207 may be equipped with emergency shut-off valves and other safety features on both ends to prevent continued flow into a ruptured, disconnected or otherwise disabled line. The line may be designed to break before causing damage to the offshore platform or the Exatron.

### Power Production System

Referring to FIG. 2, an exemplary power production system 200 is illustrated. As shown, the system 200 comprises one or more power producers (power generation modules 231a, 231b) in communication with a fuel gas supply 220 such that power generation modules 231a, 231b may receive a fuel gas stream 202 therefrom (e.g., natural gas). The power generation modules 231a, 231b are further shown to optionally be in electrical communication with an electrical transformation module 235 such that an electrical output 203 may be transmitted from the power generation modules 231a, 231b to the electrical transformation module 235.

In one embodiment, the power generation modules 231a, 231b may each comprise a generator component adapted to generate an electrical output 203 via combustion of the natural gas 202. Generally, the generator component may employ either a fuel-gas-driven reciprocating engine or a fuel-gas-driven rotating turbine to combust the natural gas 202 and drive an electrical generator.

As detailed below, each power generation module 231a, 231b may be associated with various producer information, such as operational requirements, measured or determined producer metrics, and statistics determined over a time period.

In certain embodiments, the employed power generation modules 231a, 231b may each be specified to operate with natural gas 202 having a wide variety of properties. For example, certain modules may include generator components adapted to utilize rich natural gas or natural gas that has been processed to such that it is substantially free of propane and higher hydrocarbons (C3+) components.

The producers may be associated with a gas consumption rate, which refers to the volume of natural gas consumed by the generator within a given time period. The gas consumption rate may be determined for continuous operation of the generator at standard ambient conditions. Generally, the gas consumption rate of engine-type generators may range from about 40 Mscfd to about 500 Mscfd. And the gas consumption rate of turbine-type generators may range from about 1 MMscfd to about 6 MMscfd.

The power producers may further be associated with a generated power output that refers to the electrical energy output by a given generator after efficiency losses within the generator. This property is often referred to as “real power” or “kWe.” The generated power output may be provided as “continuous power,” which refers to the real power obtained from the generator when the module is operating continuously at standard ambient conditions.

Generally, engine-type generators may produce an electrical output ranging from about 70 kW to about 2 MW, with an associated voltage ranging from about 480 V to about 4.16 kV. And turbine-type generators may produce an electrical output ranging from about 2 MW to 30 MW, with an associated voltage ranging from about 4.16 kV to about 12 kV.

It will be appreciated that the various generator components employed in the power generation module 231 may be adapted to operate reliably in harsh conditions, and with variability in gas rates, composition and heating values. Moreover, it will be appreciated that the specific generators employed in each of power generation modules 231a, 231b may be selected and configured based on the specifications and availability of natural gas at a particular location.

As shown, each of power generation modules 231a, 231b may optionally be in further communication with a backup fuel supply 237 containing a backup fuel 208. In one embodiment, the backup fuel supply 237 may comprise a natural gas storage tank containing pressurized natural gas. In another embodiment, the backup fuel supply 237 may comprise an on-vessel reserve of propane. At times of low gas availability, the backup fuel 208 may be piped directly to the power generation modules 231a, 231b, from the backup fuel supply 237.

Typically, each of the power generation modules 231a, 231b will further comprise various ancillary components (commonly referred to as the “balance of plant”). Such components may include, but are not limited to, compressors, lubrication systems, emissions control systems, catalysts, and exhaust systems. The power generation modules 231a, 231b may optionally comprise integrated emissions reduction technologies, such as but not limited to, a non-selective catalytic reduction (“NSCR”) system or a selective catalytic reduction (“SCR”) system.

In one embodiment, the power generation modules 231a, 231b may each comprise a housing designed to contain and protect the above-described components of the module. Such housing may provide features such as, but not limited to, weatherproofing, and sound attenuation.

As shown, each of the power generation modules 231a, 231b can include one or more sensors 270 for measuring or determining various power producer metrics. The modules can further include a respective controller 272 for transmitting producer information (e.g., metrics) to a controller (e.g., a master container controller 114, a site controller 117, or the remote control system 101). In certain embodiments, controllers 272 can comprise a modbus controller such that producer metrics may be retrieved from the modbus controller at predetermined intervals, for example every 15 seconds.

System 200 can further include an inlet pressure sensor 274 configured to measure the pressure of gas entering into gas supply line 220. In one embodiment, there can be a single pressure sensor 274 for an entire offshore site, and the value measured by the single inlet pressure sensor 274 can be used in correlation with each power generation module 231a, 231b fed by gas supply line 220. In another embodiment, the system may include one inlet pressure sensor per power generation module 231a, 231b. In any event, one or more controllers (e.g., a master container controller 114 or a site controller 117) may be configured for retrieving inlet gas pressure measurements from the inlet pressure sensor(s).

System 200 can also include one or more motion sensors mounted on the power generation modules 231a, 231b for measuring the movement of power generation modules 231a, 231b on the vessel 108 due to waves or tidal movement.

In some embodiments, the electrical power production system 200 may comprise an electrical transformation module 235 in electrical communication with the power generation modules 231a, 231b. In such cases, the electrical power 203a, 203b generated by each of the power generation modules 231a, 231b may be transmitted through the electrical transformation module 235 such that it may be converted into an electrical flow 205 that is suitable for consumption by the power consumption system 103.

To that end, the electrical transformation module 235 may comprise various power conditioning equipment. For example, one or more step-down transformers may be employed to reduce the voltage of an incoming electrical flow 203a, 203b by one or more “steps down” into a secondary electrical flow 205 comprising a lower voltage.

In one embodiment, a 1 MVA step-down transformer adapted to step down the voltage of an incoming electrical flow 203a, 203b having a voltage of up to about 4.16 kV. In such cases, the electrical transformation module 235 may convert the incoming electrical flow 203a, 203b to an output electrical flow 205 having a voltage of about 480 V or less.

Alternatively, when larger turbine-type power generation modules 231 are employed, the electrical transformation module 235 may reduce voltage in a plurality of steps. For example, the electrical transformation module may receive an incoming electrical flow 203a, 203b having a voltage of up to about 12 kV and may step down the voltage via multiple steps to a reduced-power output electrical flow 205 having a voltage of about 480 V or less.

In certain embodiments, the power production system may comprise a main breaker capable of cutting off all downstream electrical flows, which allows an operator to quickly de-power any attached computing equipment in the case of operational work or emergency shut-down. Additionally or alternatively, component terminals may be fitted with “quick connects.”

As shown, each of the electrical transformation modules 235 can include one or more sensors 276 for measuring or determining various producer metrics. The modules can further include a respective controller 278 for transmitting the producer metrics to a controller (e.g., container controller 114, 124 or the remote control system 101). In certain embodiments, controller 278 can comprise a modbus controller such that the metrics may be fetched from the modbus controller at predetermined intervals, for example every 15 seconds. It will be appreciated that any number of power generation modules 231a, 231b and electrical transformation modules 235 may be included in the power production system 200. For example, the power generation modules 231a, 231b may be directly wired from a terminal of each of the power generation modules 231a, 231b into a primary side of the electrical transformation module 235. As another example, two or more sets of power generation modules 231a, 231b and electrical transformation modules 235 may be employed, in a series configuration, to power any number of computing components.

It will be appreciated that, in some embodiments, a step-down transformer may not be required. For example when the output electrical flow 203 generated by the power generation module 231 comprises a voltage compatible with components of the power consumption system 103 (e.g., up to about 480V), such electrical output may be utilized without stepping-down the voltage.

In one particular embodiment, the electrical power production system 200 may comprise multiple power generation modules 231a, 231b connected in parallel. In such embodiments, the multiple electrical power generation modules 231a, 231b may be phase-synced such that their output electrical flows 203a, 203b may be combined without misalignment of wave frequency. As shown, the multiple phase-synced electrical flows 203a, 203b may be wired into a parallel panel 260, which outputs a single down-stream flow 204 with singular voltage, frequency, current and power metrics.

In one such embodiment, the singular down-stream flow 204 may be wired into a primary side of an electrical transformation module 235 for voltage modulation. For example, as discussed above, the singular down-stream flow 204 may be transmitted to the electrical transformation module 235 such that the flow may be converted into an output electrical flow 205 that is suitable for consumption by various components of the power consumption system.

Generally, each of the power generation modules 231a, 231b and/or the parallel panel 260 may comprise a control system that allows for the module to be synchronized and paralleled with other power generation modules. The control system may allow load-sharing of up to 32 power generation modules via a data link and may provide power management capabilities, such as load-dependent starting and stopping, asymmetric load-sharing, and priority selection. Such functionality may allow an operator to optimize load-sharing based on various producer metrics, for example, running hours and/or fuel consumption.

### Inventory Management and Power Consumption Distribution

In certain embodiments, the inventory system may comprise models of various components of the system 100, such as: vessels, offshore sites, power producers (e.g., power generation modules, electrical transformation modules, etc.) and power consumers (e.g., containers, DCUs, etc.).

In one embodiment, the system may determine and store offshore site information for each of the offshore sites. Exemplary offshore site information may include: offshore site ID, vessel ID, operator information, location information (e.g., address and/or coordinates), fuel gas information (e.g., heat values, volumes, composition), network equipment information, associated power producers information, and associated power consumers information (e.g., associated containers, associated power consumers).

With respect to power producers, the system may monitor, determine and/or store producer information such as: producer ID, producer type, an associated offshore site, networking information (e.g., generator modbus URL, ECU modbus URL), operations constraints and requirements, producer metrics, producer statistics, and producer controls.

As shown in Table 1, the system may monitor and/or calculate current values for some or all of the listed power producer metrics. Power producer metrics are quantifiable measures that assess operation of a power producer at a specific time.

TABLE 1
Producer Metrics

| | |
|---|---|
| Power Generation | Current generator output power (kW) |
| Engine Output | Current engine output (kW) |
| Engine Pressure | Current engine fuel pressure (psi) |
| Coolant Temperature | Current engine coolant temperature |
| | (° F.) |
| Surface Temperature | Current producer surface |
| | temperature (° F.) |
| Cylinder Positions | Current position of each cylinder |
| | (16) |
| Fuel Quality | Current fuel quality (e.g., heat |
| | value). Various operational |
| | parameters may be dynamically |
| | adjusted based on the Fuel |
| | Quality |
| Engine Run Time | Total engine run time (hours) |
| Engine Load Percent | Percent torque/available engine load |
| Engine Load % EMA | Engine Load Percentage Exponential |
| | Moving Average (we use an EMA to |
| | account for noise in the original |
| | metric fetched) |
| Is Knocking? | Compare Current Cylinder Position |
| | to Reference Cylinder Position |
| | for each cylinder. True only if |
| | at least 2 cylinders are at |
| | least 2 degrees away from their |
| | respective Reference Position |
| Fuel Consumption | Current fuel gas consumption |
| | at current Engine Output and |
| | estimated fuel gas heat value |
| | (Gross Heating Value - Dry) (mcf/d) |

In certain embodiments, the system may calculate producer statistics over one or more time periods by analyzing historical values of such metrics. Exemplary statistics include slope, standard deviation, and exponential moving average (EMA). In certain embodiments, the system determines engine pressure slope, engine pressure EMA, coolant temperature slope and/or coolant temperature EMA. Such statistics may be determined for various time periods.

As shown in Table 2, power producers may be associated with certain operational requirements that must be observed and can be used to create setpoints for determining target powers for the power producers. Such requirements may be predetermined (e.g., based on producer type) or may be dynamically adjusted according to values of certain producer metrics (e.g., based on a current Knock Index).

TABLE 2
Producer Operational Requirements

| | |
|---|---|
| Max Engine Output | Maximum engine output |
| | power (kW) Target power |
| | should be below this. |
| Max Generator Power | Maximum generator |
| | output power (kW) |
| Max Engine Load Percent | Maximum Engine Load |
| | Percent |
| Min Engine Pressure | Minimum engine fuel |
| | pressure to be |
| | maintained (psi) |
| Max Cylinder Exhaust | Maximum cylinder exhaust |
| Temperature | temperature for any |
| | given cylinder (° F.) |
| Reference Cylinder | |
| Position | |
| Min Inlet Pressure | Minimum inlet fuel |
| | pressure to be |
| | maintained (psi) |
| Max Coolant | Maximum engine coolant |
| Temperature | temperature (° F.) |
| T5 Temperature | Maximum surface temperature |
| | generator can reach under |
| | normal operating conditions |

The system may also model and manage power consumers information for any number of power consumption systems. Such information may comprise: a unique ID, associated container information, and consumer information for each power consumer associated with each of the associated containers.

Generally, exemplary container information may include: container ID, associated offshore site, associated vessel, associated power producers, container type (e.g., manufacturer, model), networking information (e.g., container modbus URL), VLANs information (e.g., main, ASIC, IoT, etc.), controller information (controller ID, IP address, IP port), layout information of DCUs inside a container, associated DCUs, and various container metrics.

The embodiments may also manage power consumer information for each consumer. Exemplary consumer information may include, but is not limited to: unique ID, hardware identifier, network information, associated container and location information, consumer type (e.g., manufacturer, model), processor information (e.g., type, count, temperature, etc.), fan speed, hashrate, board information (e.g., temperature), software information, uptime, financial information (e.g., mining pool, pool user), owner information, status information and/or priority information.

Generally, each of the consumers (e.g., DCUs 112, 122) has a preassigned unique hardware identifier accessible to the system orchestrator 130c via the network. For example, the preassigned unique hardware identifier can be a media access control (MAC) address. Each of the consumers can also be associated with a unique inventory identifier that is different from the MAC address and is an ID assigned by the system orchestrator 130c. User device 138 can be a client computer, for example a mobile phone.

Each of DCU 112, 122 is connected to a respective one of the network interfaces 136, for example by an ethernet cable of the network 134 that is in communication with the network interface 136 being plugged into a port of the new DCU 112, 122.

As mentioned above, each container may be associated with layout information corresponding to a plurality of racks disposed within a container. Each rack may comprise a plurality shelfs, where each shelf comprises various slots into which DCUs may be installed. Accordingly, each slot represents a unique physical location that may be employed to determine the physical location of a particular DCU if such components are correlated by the system.

To that end, each slot may be configured to include one of the network interfaces 136 of the communication system 132, wherein each interface may be assigned a unique, static network address. Accordingly, when a DCU is connected to the particular network interface 136, the DCU is automatically associated with the corresponding network address. Because the network address uniquely identifies a particular slot, in a shelf of a rack located in a container disposed at an offshore site, the network address association allows for a physical location to be determined.

As described further below, the new DCU 112, 122 may be connected to the respective network interface 136 at a specific location on a rack in the physical container and the position of the respective network interface within the physical container 110, 120 including the specific location of the new DCU on the rack.

The system orchestrator 130c is configured to automatically determine location information including the physical container 110, 120 in which the respective network interface 136 is located and a position of the respective network interface 136 within the physical container 110, 120 based on the network address of the respective network interface 136. Each of the network interfaces 136 can have preassigned container identifier, a preassigned rack identifier, a preassigned shelf identifier and a preassigned shelf position identifier, and this information is automatically determined by the system orchestrator 130c upon the connecting of the new DCU 112, 122 to the network interface 136.

The container orchestrator 114c can monitor and update further metrics of each DCU by periodically sending a metrics request to the DCU, and the DCU sending the metrics in response to the request. For example, each DCU can include a plurality of hashboards, with each hash board including a plurality of chips. The container orchestrator 114c can periodically send the metrics request to the DCU to obtain a maximum chip temperature for the chips on a hashboard, along with average temperature for each hashboard, and the hashrate of the DCU.

The system orchestrator 130c can associate the location information with a corresponding object in the inventory model. As noted above, this location information can include the physical container 110, 120 in which the new DCU 112, 122 is located and the position of the respective network interface 136 within the physical container 110, 120. This location information can be in the form of a preassigned container identifier, a rack identifier, a shelf identifier and a shelf position identifier.

Data records for containers 110, 120 include container information of each of the physical containers 110, 120. The container information can include information describing the geographical location of the physical container, a container identifier for the physical container, a size of the physical container, a type of the physical container and a cost of the physical container. The data records for DCUs 112, 122 include position information for each of the DCUs in communication with the network 134. The position information can include a position of the distributed computing unit within the respective physical container, including at least one of a rack, a shelf and a slot where the distributed computing unit is positioned within the respective physical container. The container information and/or position information are automatically assigned to each DCU 112, 122 in communication with the network 134 based on the network address of the respective network interface 136.

The physical containers 110, 120 can each include a plurality of racks having predefined rack positions configured for receiving the DCUs, and each of the predefined rack positions can be associated with one of the network interfaces. Memory 130b can be partitioned to store the predefined rack positions and the associated network interfaces, and the system orchestrator 130c can be configured to automatically assign the predefined rack position associated with the network interface 136 with which the DCU is connected to the corresponding data record.

The physical containers 110, 112 can be located at different offshore sites and each of the offshore sites can have at least one of the physical containers 110, 112 and at least one of the offshore sites can have a plurality of physical containers. The system orchestrator 130c can be configured for causing the processor to generate a graphical user interface depicting the offshore sites, the physical containers within the offshore sites, the predefined rack positions within the containers, and the DCUs in the predefined rack positions.

The container information and/or position information of each DCU can be dynamically adjusted by the system orchestrator 130c in response to a disconnection of the DCU from the respective network interface 136 and a reconnection of the DCU to a different network interface in a different physical container or the same physical container.

In embodiments where DCUs 112, 122 each include a plurality of GPUs, the data record can include a number of GPUs for each DCUs 112, 122, a number of currently available GPUs for each DCU 112, 122, and a number of currently utilized GPUs for each DCU 112, 122. During operation, each GPU can run a single virtual machine alone or together with one or more of the other GPUs of the respective DCU 112, 122 and the data record can include the one or more GPUs running each virtual machine. The data record can also include the number of GPUs of each DCUs currently running virtual machines and an excess capacity for running further virtual machines for each DCU.

In embodiments where DCUs 112, 122 are cryptocurrency miners, the data records can include financial metrics related to the cryptocurrency miner. The financial metrics can include at least one of a purchase price of the cryptocurrency miner, a depreciation of the cryptocurrency miner or a profit generated by the cryptocurrency miner. Each of the data records can also include repair and/or maintenance history information for the cryptocurrency miner including financial costs associated with the repair and/or maintenance. Further, each of the data records can include a hash rate for the cryptocurrency miner.

Memory 130b can store information with respect to containers 110, 112, racks, and individual DCUs. For example, metrics for a specific container can include the total number of DCUs online and offline for the container, the total hashrate of all of the DCUs of the container together (current value and over time on a graph), a mining pool hashrate, the load of the generator powering the DCUs of the container, a current fuel consumption generator powering the DCUs of the container, the power consumption by the DCUs of the container over time shown in graph, the gas pressure of the generator powering the DCUs of the container over time shown in a graph, an average maximum chip temperature for the DCUs of the container over time shown in a graph.

With respect to computing resource allocation for DCUs 112, 122, first container orchestrator 114c is configured to store in the first controller memory 114b or periodically transmit data including a total power consumption capacity and a currently available power consumption capacity for each of the first DCUs 112. Similarly, second container orchestrator 124c is configured to store in the second controller memory 124b or periodically transmit data including a total power consumption capacity and a currently available power consumption capacity for each of the second DCUs 122. The system orchestrator 130c is configured for communicating with the first and second container orchestrators 114c, 124c to obtain the total power consumption capacity and the currently available power consumption capacity for groups of the DCUs 112, 122.

Container orchestrators 114c, 124c can also create a consumer object in memory 114b for all of the DCUs 112, 122 within the respective container 110, 120 or can create more than one consumer objects from the DCUs 112, 122 within the respective container 110, 120, with subsets of DCUs 112, 122 being in different consumer objects based on utility values of the DCUs, as described in further detail below. For example, DCUs 112 in container 110 can group into separate consumer objects including DCUs having a utility value within a first range being represented by a first consumer object, DCUs having a utility value within a second range being represented by a second consumer object, and DCUs having a utility value within a third range being represented by a third consumer object. Container orchestrators 114c, 124c fetch real time power consumption metrics for the respective DCUs 112, 122c and combines these real time power consumption metrics to populate a record associated with each of the consumer objects in real time with the cumulative power consumption values for the DCUs represented by the respective consumer object.

As briefly noted above, FIG. 3 shows a method 300 of balancing load created by various components of a power consumption system with an optimal power output determined for a power production system.

As discussed above, the disclosed embodiments may include automated control devices that are configured to monitor the operation of power producers of the power production system, and adjust the operation of power consumers based on producer metrics and/or operational requirements.

Generally, the embodiments provide an automated method for determining a target output power for the power production system based on various metrics, statistics and/or operational constraints of devices of the power production system; determining operational parameters of power consumers of the power consumption system; and adjusting the operation of one or more power consumers such that the power consumption system is modified to provide a load that substantially meets the target output power. In this way, the embodiments allow for an optimal output power to be provided by the power production system while balancing power demand of the power consumption system.

In a first step 302, method 300 includes measuring and/or receiving metrics of power production system 200 and metrics related to power consumption system 103. This step 302 can include receiving real time metrics for each of the devices of power production system 200. Devices of power production system 200 can be the power generation modules 231, the electrical transformation module 235 and/or gas supply line 220. Other devices of power production system 200 can include a compressor/engine assembly for providing compressed natural gas to power generation module 231, or devices that monitor parameters that impact the production and/or delivery of power to DCUs 112, 122, which include pressure sensor 274 or a gas flow meter used in place of pressure sensor 274. In other words, the devices of power production system 200 are devices that impact the power supply by system 200 or monitor variables impacting the power supply by system 200.

Metrics of power generation modules 231 can advantageously include power generation metrics mentioned above, including an engine pressure, a generator output, an engine output, a coolant temperature, a percent engine load, cylinder positions of the engine, and/or a knock index. One of power control modules 114d, 124d can retrieve sensor data for a plurality of control variables from the corresponding respective controller 272. The power generation metrics can be fetched by the respective power control module 114d, 124b from controller 272 at predetermined intervals.

Metrics of electrical transformation modules 235 can also include one or more transformer metrics, including a temperature of electrical transformation module 235 retrieved from sensor 276 by respective power control modules 114d, 124d at the predetermined intervals. Electrical transformation module 235 can include its own controller 278 for fetching metrics from sensor 276, or controller 272 can be in communication with sensor 276 and can fetch metrics from sensor 276.

Metrics of gas supply line 220 can be the pressure of gas entering into gas supply line 220, retrieved from inlet pressure sensor 274 by respective power control modules 114d, 124d at the predetermined intervals. Pressure sensor 274 can include its own controller for fetching metrics from sensor 274, or controller 272 can be in communication with sensor 274 and can fetch metrics from sensor 274.

Other metrics can also be gathered, including one or more business metrics, such as a maintenance schedule, retrieved from a business database 148 at the predetermined intervals.

A next step 304 is determining a target power production framework that includes a target power delta for each device associated with the power generation system 200 based on the metrics of power production system 200.

Each of the different target power deltas is based on a different energy producer metric. Step 304 can include running each of the metrics through a distinct PID (Proportional-Integral-Derivative) controller to determine a target power for each of the metrics. For example, referring to the above-described devices, each power generation metric, each transformer metric and each offshore site metric can be run through a distinct PID controller to determine a distinct target power delta for each distinct power generation metric, each distinct transformer metric and each distinct offshore site metric. Power control modules 114d, 124d can run all of the PID controllers simultaneously to generate the target power deltas for each metric.

The system can compare the energy producer metric to a predetermined setpoint for the respective power generation metric, then outputs an error of the difference between the respective producer metric and the setpoint. The error has a proportionality to the amount of the respective power generation metric differs from the setpoint, and this proportionality is used to calculate the target power delta for the respective power generation metric. As noted above with respect to Table 2, the setpoints can be a function of power producer operational requirements.

A target power delta is then selected for each device from the calculated different target power deltas. For each of the devices for which more than one target power delta is calculated, step 304 includes selecting a minimum target power delta from amongst the target power deltas for the device as the selected target power delta for the device. For each of the devices for which only a single target power delta is calculated, step 304 includes selecting the single target power delta as the selected target power delta for the device

For example, as shown below in Table 3, if the target power delta for the engine pressure is +10 KW, the target power delta for the generator output is −5 KW, the target power delta for the engine output is −15 KW, the target power delta for the coolant temperature is +20 KW, the target power delta for the percent engine load is +30 KW, the target power delta for the cylinder positions of the engine is −10 KW, and the target power delta for the knock index is +15 KW, then the target power delta for the engine output is the minimum target power delta, and −15 KW is the selected power delta for the power generation module 231. This conservative approach can advantageously prevent shutdowns power generation modules 231 of power production system 200 while maximizing the operating production of DCUs 112, 114 as a whole.

TABLE 3

| | Target power delta | |
|---|---|---|
| engine pressure | +10 | KW |
| generator output | −5 | KW |
| engine output | −15 | KW |
| coolant temperature | +20 | KW |
| percent engine load | +30 | KW |
| cylinder positions of the engine | −10 | KW |
| knock index | +15 | KW |
| minimum generator target power delta | −15 | KW |

If only a single metric is analyzed for one of devices, such as for example only the temperature for electrical transformation module 235 or only the pressure of entry gas for gas supply line 220, then the target power delta for said single metric is selected as the target power delta for the device 235 or 220.

A next step 306 is determining an optimal power consumption distribution model for the computing units 112, 122 based on the target power production framework and the metrics related to power consumption system 103. As discussed in further detail below, the optimal power consumption distribution model takes into consideration power directives associated with the devices of power production system 200 along with constraints of at least one of said devices, and selects DCUs 112, 122 for achieving the optimal power consumption distribution model. Each of the power directives is device-specific and takes into account the selected target power delta for the device.

In one advantageous example that helps to maximize the use of computing resources with causing operational problems of power production system 200, as described in further detail below, step 306 involves considering the selected target power delta for each device individually as a device-specific power directive, and then applying the device-specific power directive in the optimal power consumption distribution model determination to a set of the computing units, which can be represented together by a consumer object, associated with the respective device. By associated with, it is meant that the device impacts the power supply to the computing unit or monitors variables impacting the power supply to the computing unit. A device impacting the power supply can be any device involved in the production of power that is supplied to the computing unit, or any device involved in the delivery of this generated power to the computing unit. A device that monitors variables impacting the power supply to the computing unit can be any sensor measuring parameters of fuel delivered to a power production device or measuring parameters in the production or delivery of the power supplied to the computing unit.

The determination of the optimal power consumption distribution model can involve applying a series of power directives that are each capable of altering a previously applied power directive if the modeled power consumption distribution of the previously applied power directive(s) does not comply with the current power directive. Power constraints of at least one of the devices can also limit the power directive to constrain the modeled power consumption distribution. In one example, the device-specific power directives are first applied in a first calculation pass to output a modeled power consumption distribution, then the at least one device power constraint is applied to the modeled power consumption distribution resulting from the first calculation pass in a second calculation pass to output the optimal power consumption distribution model. This order of operations provides more flexibility, as applying the at least one device power constraint prior to the power directives would more strictly limit the optimal power consumption distribution model.

In particular, this step 306 includes a plurality of substeps illustrated in FIG. 3b. A first substep 306a includes identifying which of the consumer objects are available for power modification during the optimal power consumption distribution model determination based on one or more consumption constraints. consumer objects can be categorized as unavailable according to different consumer constraint directives. consumer objects can represent a group of DCUs that are categorized together based on one or more characteristics. In an advantageous example, the characteristic used to categorize DCUs into a group is a utility value of each of the DCUs. As discussed below, the utility value can represent a monetary value of operating the DCU in comparison to power consumption, or a predetermined range of the monetary value of operating the DCU in comparison to power consumption. More specifically, the utility value can be the revenue or profit generated by the DCU per unit of energy, such as dollar per KWh or joules. For DCUs, the utility can be based on the model of the DCU, as DCUs of the same model have the same or approximately the same (+/−10%) monetary value of operating the DCU in comparison to power consumption.

The availability status of the consumer object can be represented in the respective controller memory 114b, 124b. The availability status can be input into a human machine interface of computing unit in communication with control system 101 and stored in business database 148. Upon one of power control modules 114d, 124b being elected as the leader, the consumer object availability statuses can be pushed from business database 148 by coordinator 130 to the leader, then stored in the respective memory 114b, 124b, and is retrieved from the controller memory 114b, 124b by the respective power control module 114d, 124d in substep 306a.

In substep 306a, consumer objects that represent computing units used to provide services to third parties can be categorized as unavailable due to a third party service directive. The power consumption of these computing units is dictated by computing operations being performed by the third parties, and power deltas are not distributed to the consumer objects representing these computing units by the power directives or by the at least one device power constraint. The computing units represented by such consumer objects can be computing units used to provide cloud services to remote client computers.

Other consumer objects can be categorized as unavailable due to a constant power classification. These consumer objects are assigned a constant power and are unavailable for any power delta, and can be completely excluded from the optimal power consumption distribution model determination.

Further, consumer objects can be categorized as unavailable due to a positive power delta directive. These consumer objects are assigned a positive constant power delta that is applied to the optimal power consumption distribution model determination. A positive power delta directive can be initiated by an on-site maintenance worker who needs to power up a container of computing units back on after a maintenance operation and has determined that such a power up operation will not damage any device of power system.

Consumer objects that are not categorized as unavailable for power consumption redistribution in the optimal power consumption distribution model determination may be categorized as available for power consumption redistribution in the optimal power consumption distribution model determination.

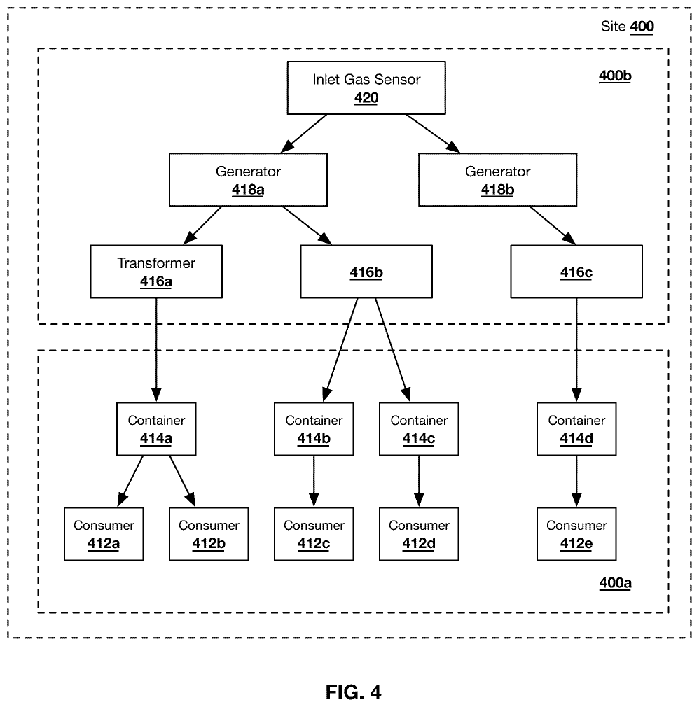

FIG. 4 schematically shows a simplified power consumption distribution model 400 and helps to illustrate the substeps of step 306. Model 400 includes a consumer section 400a and a producer section 400b and visualizes the relationship of devices of an exemplary power production system and an exemplary power consumption system.

Section 400a illustrates consumer objects 412a to 412e, which can each represent a group of DCUs, and containers 414a to 414 housing the DCUs represented by consumer objects 412a to 412e. DCUs represented by consumer objects 412a, 412b are housed within container 414a, DCUs represented by consumer objects 412c is housed within container 414b, DCUs represented by consumer objects 412d is housed within container 414c and DCUs represented by consumer objects 412e are housed within container 414d. Each consumer object 412a to 412e can represent a group of computing units having a similar profile. For example, consumer objects 412a, 412b in container 412a can each includes a group of bitcoin miners having a similar profile, with consumer object 412a including only bitcoin miners of a first model or a first set of models having a hashrate per unit of energy consumed within a predetermined range, and consumer object 412b including only bitcoin miners of a second model different from the first model or a second set of models having a hashrate per unit of energy consumed in a predetermined range that is different from the predetermined range of the first set of model. As another example, consumer object 412e can include only GPUs providing cloud services to third parties.

Section 400b illustrates devices in the form of transformers 416a to 416c, generators 418a to 418c, and an inlet pressure sensor 420.

In relation to substep 306a, consumer objects 412c to 412e are categorized as being unavailable for power consumption redistribution in model 400 under different consumer constraint directives. consumer object 412c is categorized as unavailable due to a positive power delta directive. consumer object 412d is categorized as unavailable due to a constant power directive. consumer object 412e is categorized as unavailable due to a third party service directive.

A next substep 306b in the optimal power consumption distribution model determination is applying the device-specific power directives to the computing units categorized in substep 306a as being available for power consumption redistribution.

The power directives can include a first power directive distributing the selected power delta for a first device of power production system 200 to at least one available consumer object whose power supply is impacted that monitor parameters that impact the production by the first device and/or delivery of power by the first device. In other words, the first power directive distributes the selected target power delta for the first device to a first set of the computing units. The first set of the computing units are those which are associated with the first device and which are available for inclusion in the modeled power consumption distribution.

The first device can for example be generator 418a in FIG. 4, and the first power directive can be based for example on the example discussed with respect to step 304 and shown above in Table 3, where the target power delta for the engine output is the minimum target power delta, and −15 KW is selected as the target power delta for the power generation module 231.

The first power directive can be distributed on a consumer object-by-consumer object basis, so the −15 KW power delta is distributed to consumer objects 412a, 412b, without it being determined how the target power delta is distributed on a computing unit-by-computing unit basis. In this example, container 414a includes two consumer objects 412a, 412b and each of containers 414b to 414d includes a single respective consumer object 412c to 412e. In other examples, there can be more than two or more groups of DCUs per container, or a single group of DCUs can include the computing units of two or more containers, with each group represented by a respective consumer object. Each consumer object 412a to 412e can include tens or hundreds of computing units.

Although the production of power to consumer objects 412a to 412d in containers 414a to 414c is impacted by (here generated by) generator 418a, consumer objects 412c, 412d can be categorized as unavailable for power consumption redistribution in model 400, and thus only consumer objects 412a, 412b of container 414a are available for power consumption redistribution in model 400. The computing units represented by consumer objects 412a, 412b would thus be the first set of the computing units as they are associated with the first device and are available for inclusion in the modeled power consumption distribution. As noted above, consumer object 412c is categorized as unavailable due to a positive power delta directive and consumer object 412d is categorized as unavailable due to a constant power directive (i.e., target power delta is 0). For example, if the positive power delta directive requires a target power delta of +5 KW, this would impact the first power directive, and the first power directive would require a −20 KW target power delta distributed solely to consumer objects 412a, 412b.

As another example, assume consumer objects 412a to 412d are all available for power consumption redistribution in model 400. The computing units represented by consumer objects 412a to 412d would thus be the first set of the computing units as they are associated with the first device and are available for inclusion in the modeled power consumption distribution. Each of consumer objects 412a to 412d is assigned a utility value that is used to distribute the first power directive amongst consumer objects 412a to 412d. In one example, the utility value represents a generated monetary value in comparison to power consumption. More specifically, the utility value can be the revenue or profit generated per unit of energy, such as dollar per KWh or joules. If a consumer object represents bitcoin miners, the revenue generated per unit of energy depends on the total hashrate of the bitcoin miners represented by the consumer object per unit of energy and the current price of bitcoin. If all of consumer objects 412a to 412d for example only include bitcoin miners, the utility value analyzed could be simply the total hashrate per unit of energy consumed for the group of bitcoin miners represented by each consumer objects 412a to 412d. In such an example, as shown in Table 4, assuming each of consumer objects 412a to 412d includes at least tens of miners, and the miners of consumer object 412a have a total hashrate per unit of energy consumed that is lower than the total hashrate per unit of energy of the miners of consumer object 412b, lower than the total hashrate per unit of energy of the miners of consumer object 412c, and also the total hashrate per unit of energy of the miners of consumer object 412d, the minimum target power of generator 418a is applied as the first power directive to consumer object 412a, resulting in a −15 KW power delta for consumer object 412a.

TABLE 4

| consumer object | Utility value |
|---|---|
| consumer object 412a | 1.0 TH/KW |
| consumer object 412b | 3.0 TH/KW |
| consumer object 412c | 5.0 TH/KW |
| consumer object 412d | 6.0 TH/KW |

As discussed above, computing units can be grouped together into consumer objects in different manners than containers and a power directive can consider such different groups when distributing the minimum target power of generator 418a. For example, each of containers 414a to 414c can include two or more consumer objects, and these consumer objects can be considered when applying a power directive. If a first consumer object representing DCUs in container 414a has a lower utility than the other consumer objects representing DCUs in container 414a, and all of the consumer objects representing DCUs in containers 414b, 414c, then a power directive with a negative power delta is applied to the first consumer object representing DCUs in container 414a. If a first consumer object representing DCUs in container 414c has a higher utility than the other consumer objects representing DCUs in container 414c, and all of the consumer objects representing DCUs in containers 414a, 414b, then a power directive with a positive power delta is applied to the first consumer object representing DCUs in container 414c. The consumer objects can be established based on the computing efficiency of the computer units, which can be a result of the computing unit model. Container 414a can thus be associated with for example a first consumer object representing bitcoin miners each having a first hashrate per unit of energy, a second consumer object representing bitcoin miners each having a second hashrate per unit of energy lower than the first hashrate per unit of energy and a third consumer object representing bitcoin miners each having a third hashrate lower than the second hashrate. In other examples, the consumer objects can include a first consumer object representing bitcoin miners having a first range of hashrates per unit of energy, a second consumer object representing bitcoin miners having a second range of hashrates including a highest hashrate that is lower than a lowest hashrate in the first range, and a third consumer object representing bitcoin miners having a third range of hashrates including a highest hashrate that is lower than a lowest hashrate in the second range.

If a consumer object having the lowest utility does not have available power to receive a full power delta of a power directive, part of the first power directive is applied to the lowest utility consumer object associated with the device, then the rest is applied to the consumer object with the next lowest utility. For example, referring to Table 4, if consumer object 412a is only operating at 10 KW, then −10 KW of the −15 KW power delta of the first power directive is applied to consumer object 412a, and the remaining −5 KW power delta is applied to consumer object 412b, which is the consumer object with the next lowest utility.

The power directives can include a further first power directive distributing the selected power delta for a further first device of power production system 200 to available computing units associated with the further first device. The further first device can be generator 418b, and the computing units associated with generator 418b are represented by consumer object 412e.

In some embodiments, two or more generators can be synced together to provide a single power output. A target power delta can then be calculated for each generator separately in step 304, and the target power deltas can be considered together for applying a single power directive for the synced generators. If the synced generators have a power delta of the same sign (positive or negative), the power deltas are added together to determine the target power applied in the single power directive. For example, if two generators are synced together, and each has a +5 power delta, the power delta applied by the power directive is +10, and each has a −5 power delta, the power delta applied by the power directive is −10. If the synced generators have a power delta of the opposite sign (positive or negative), the negative power delta is applied in the single power directive. For example, if two generators are synced together, and one has a +5 power delta and the other has a −5 power delta, the power delta applied by the power directive is −5.

The power directives can also include a second power directive distributing the selected target power delta for a second device of power production system 200 to a second set of the computing units. The second set of the computing unit are those which are associated with the second device and which are available for inclusion in the modeled power consumption distribution.

The second power directive can for example relate to transformer 416a in FIG. 4. A temperature of transformer 416a can be input into a PID loop to determine a target power delta for the temperature. If no other metrics are analyzed for target power deltas for transformer 416a, the target power delta for the temperature is used as the selected target power delta for transformer 416a (step 304).

For example, because of the primary importance of the generator operating without failure to supplying power to the computing units, a power directive from a transformer cannot be used to increase a power delta distributed by a generator power directive because it could increase the chances of a shutdown. A power directive from a transformer can however be used to decrease a power delta distributed by a generator power directive to avoid overheating of the transformer. In other words, applying the second power directive can include determining that the second power directive is more conservative than the first power directive as cumulatively applied to the computing units of the first set, and then applying the second powered directive to decrease the target power delta distributed to at least one of the computing units of the second set by the first power directive.

Referring back to the example where all of consumer objects 412a to 412d are available for power modification, it is assumed that the transformers 416a, 416b and generator 418a have the power directives as shown in Table 5, and the generator power directive of −15 KW was distributed to consumer object 412a. Transformer 416a can be considered the second device and transformer 416b can be considered the further second device. The computing units represented by consumer objects 412a, 412b would thus be the second set of the computing units as they are associated with the second device (transformer 416a) and are available for inclusion in the modeled power consumption distribution. The computing units represented by consumer objects 412c, 412d would thus be the further second set of the computing units as they are associated with the further second device and are available for inclusion in the modeled power consumption distribution. It is noted that all of the computing units in the second set (consumer objects 412a, 412b) and the further second set (consumer objects 412c, 412d) are also in the first set (consumer objects 412a to 412d), only some of the computing units in the first set are also in the second set, only some of the computing units in the first set are also in the further second set, and the computing units of the second set are distinct from the computing units of the further second set.

TABLE 5

| Device | Power Directive | |
|---|---|---|
| Transformer 416a | +5 | KW |
| Transformer 416b | −20 | KW |
| Generator 418a | −15 | KW |

Applying the second power directives of transformers 416a, 416b can include determining that the second power directives are more conservative than the first power directive of generator 418a as cumulatively applied to the computing units of the first set (i.e., computing units represented by consumer objects 412a to 412d). As the first power directive of generator 418a as cumulatively applied to the computing units represented by consumer objects 412a to 412d has a target power delta of −15 KW, only the second power directive of transformer 416b has a target power delta (−20 KW) that is more conservative than the first power directive of generator 418a. Thus, only the second power directive of transformer 416b is applied to decrease the target power delta distributed to the computing units represented by consumer objects 412c, 412d because the consumer objects 412c, 412d affected are of lower priority and take all of the target power delta. It should be understood that this power directive application includes verifying that the current state of the consumer objects affected by the directive results in a power decrease of greater than or equal to the power directive.

Because transformer 416b has a power directive of −20 KW, and available consumer objects 412c, 412d associated with transformer 416b both have a 0 KW power delta after the first power directive, the power control module (e.g., power control module 114d or 124d) determines which of consumer objects 412c, 412d has the lowest utility by fetching utility data from the respective container orchestrator (e.g., container orchestrator 114c or 124c), and then distributes the −20 KW power delta to the consumer objects 412c, 412d having the lowest utility, which based on the example of Table 4 is consumer object 412c. Utility values for consumer objects can be set at the orchestrator level by manual inputs, for example as the mean power efficiency of the DCUs that constitute the consumer object, or can be determined based on data fetched from the DCUs by container orchestrators 114c, 124c, including for example fetching a hashrate and a power consumption from a cryptocurrency miner and multiplying these values times each other. These utility metrics can also be fetched by container orchestrators 114c, 124c from business database 148. As the power directive of transformer 416a has a positive value, this power directive of transformer 416a is ignored.

TABLE 6

| | Modeled Power Delta | |
|---|---|---|
| consumer object | after 2nd Power Directive | |
| consumer object 412a | −15 | KW |
| consumer object 412b | 0 | KW |
| consumer object 412c | −20 | KW |
| consumer object 412d | 0 | KW |

The power directives can include a third power directive distributing the determined selected target power delta for a third device of power production system 200 to a third set of the computing units associated with the third device.

The third power directive can for example relate to a device that measures a parameter of natural gas being supplied to the power generation module. The device that measures a parameter of natural gas being supplied to the power generation module can be an inlet pressure sensor 420 that is in a line feeding gas to all of generators 418a to 418c in FIG. 4. The inlet pressure measured by sensor 420 can be input into a PID loop to determine a target power delta for the inlet pressure. If no other metrics are analyzed for target power deltas for sensor 420, the target power delta for the inlet pressure is used as the selected target power delta for sensor 420 (step 304). In other examples, instead of a sensor 420, the device that measures a parameter of natural gas being supplied to the power generation module can be inlet pressure or inlet flow sensors of the generators, and measurements can be retrieved from the inlet pressure or inlet flow sensors of the generators to estimate the pressure in fuel gas supply line 220. In particular, if there are three generators supplied by fuel gas supply line 220, values from pressure or flow sensors of the generators are retrieved, and an average value is taken for these sensors to estimate the pressure in fuel gas supply line 220. In other examples, the device that measures a parameter of natural gas being supplied to the power generation module can be a gas flow meter in fuel gas supply line 220. If the pressure of flow in fuel gas supply line 220 for example is too low, a negative power delta can allow the pressure in fuel gas supply line 220 to build up to more optimal levels for operating the generators.

Similar to the second power directive, because of the primary importance of the generator operating without failure to supplying power to the computing units, a power directive from a sensor 420 cannot be used to increase a power delta distributed by a generator power directive because it could increase the chances of a shutdown. A power directive from sensor 420 can however be used to decrease a power delta distributed by a generator power directive to avoid the pressure of gas in for example gas supply line 220 from being too low.

As example, it is assumed that all of consumer objects 412a to 412e are all available for power consumption redistribution in model 400, and the devices have power directives as shown in the below Table 7.

TABLE 7

| Device | Power Directive | |
|---|---|---|
| Transformer 416a | +5 | KW |
| Transformer 416b | −20 | KW |
| Transformer 416c | +10 | KW |
| Generator 418a | −15 | KW |
| Generator 418b | +15 | KW |
| Pressure sensor 420 | −45 | KW |

The devices discussed above with respect to Table 4 have maintained the same power directives, and thus the distribution to consumer objects 412a to 412d in Table 5 applies to begin the analysis with respect to the application of the third power directive. Prior to the modeling of the third power directive, consumer object 412a thus has −15 KW power delta, consumer object 412b has a 0 KW power delta, consumer object 412c has a −20 KW power delta, and consumer object 412d has a 0 KW power delta. As the power directive (+10 KW) of transformer 416c is more conservative than the power directive (+15 KW) of generator 418b, the power directive (+10 KW) of transformer 416c overrides the power directive (+15 KW) of generator 418b, and consumer object 412e has a +10 KW power delta achieving the modeled power distribution shown in Table 8.

TABLE 8

| | Modeled Power Delta | |
|---|---|---|
| consumer object | after 2^{nd} Power Directive | |
| consumer object 412a | −15 | KW |
| consumer object 412b | 0 | KW |
| consumer object 412c | −20 | KW |
| consumer object 412d | 0 | KW |
| consumer object 412e | +10 | KW |

The power directive for pressure sensor 420 is then to be distributed amongst consumer objects 412a to 412e, because sensor 420 monitors a parameter than impacts power generation for the computing units in each of these consumer objects 412a to 412e. In the modeled power distribution prior to the application of the power directive of pressure sensor 420, the cumulative power delta of consumer objects 412a to 412e is −25 KW ((−15)+(0)+(−20)+(0)+(10)=−25). A decrease of −20 KW is thus needed to satisfy the power directive of pressure sensor 420. Because applying −20 KW would not increase the overall power delta applied by any of the generator power directives or the transformer power directives, the leader power control module (e.g., power control module 114d) determines which of consumer objects 412a to 412e has the lowest utility by accessing the utility database, and then distributes the −20 KW power delta to the consumer object 412a to 412e having the lowest utility, which based on the example of Table 9 is container 414a, achieving the modeled power delta in Table 10 for the consumer objects.

TABLE 9

| consumer object | Utility value |
|---|---|
| consumer object 412a | 1.0 TH/KW |
| consumer object 412b | 3.0 TH/KW |
| consumer object 412c | 5.0 TH/KW |
| consumer object 412d | 6.0 TH/KW |
| consumer object 412e | 4.0 TH/KW |

TABLE 10

| | Modeled Power Delta | |
|---|---|---|
| consumer object | after 3rd Power Directive | |
| consumer object 412a | −35 | KW |
| consumer object 412b | 0 | KW |
| consumer object 412c | −20 | KW |
| consumer object 412d | 0 | KW |
| consumer object 412e | +10 | KW |

It is noted that the terms first device, second device and third device do not identify any specific device and the terms first power directive, second power directive and third power directive do not identify any specific device power directive. For example, the power directive for the pressure sensor 420 can be considered the second power directive. Accordingly, it can be said that the second device measures a parameter of natural gas being supplied to the power generation module, and all of the computing units in the first set (e.g., consumer objects 412a to 412d) are also in the second set (e.g., consumer objects 412a to 412e) and only some of the computing units in the second set are also in the first set

A next substep 306c in the optimal power consumption distribution model determination is applying the at least one device constraint to the modeled power distribution resulting from substep 306b. Substep 306c can include limiting the target power production framework resulting from step 304 by applying at least one constraint of at least one of the devices to determine the optimal power consumption distribution model.

Specifically, the limiting of the target power production framework from step 304 includes applying to the at least one constraint of at least one of the devices to the modeled power distribution resulting from the application of the power directives in substep 306b, such that each constraint alters at least one of the target power deltas applied to the computing units associated with the respective device when the target power deltas applied to the computing units associated with the respective device in the modeled power distribution cumulatively cause a violation of said constraint.

For example, the limiting of the target power production framework from step 304 can include applying to the at least one constraint of generator 418a to the modeled power distribution resulting from the application of the power directives in substep 306b, such that each constraint alters at least one of the target power deltas applied to consumer objects 412a to 412d associated with the generator 418a when the target power deltas applied to generators 418a in the modeled power distribution resulting from substep 306b cumulatively cause a violation of said constraint.

Device constraints can include a predefined maximum power of a generator, a predefined minimum power of a generator, a predetermined maximum ramp up rate of the generator and/or a predetermined minimum ramp down rate of a generator, and substep 306c can involve analyzing the modeled power distribution resulting from substep 306b in view of each of these device constraints.

The device constraints can be analyzed in terms of absolute power or a power delta. In particular, a predefined maximum power of a generator and a predefined minimum power of a generator are analyzed in terms of absolute power, while a predefined maximum ramp up and/or predefined minimum ramp down rate of a generator are analyzed in terms of a power delta.

With respect to a predefined maximum power of a generator, this maximum power is compared to the determined absolute target power for the generator resulting from the substep 306b. This absolute target power is the target power delta for the generator at the end of substep 306b plus the current power of the generator. In other words, the absolute target power is the current power of the generator plus the generator target power delta from the first power directive (i.e., generator target power delta from substep 306a), and any decrease of the generator target power delta resulting from the subsequent power directives (e.g., the second and third power directives) plus the current power of the generator.

Referring to the example shown in Table 10, if the current power of the generator 418b is 450 KW, and the predefined maximum power of generator 418b is 455 KW, a target power delta of +10 KW for the consumer object 418e powered by generator 418b resulting from substep 306b would result in an absolute target power of 460 KW violating this predefined maximum power. The target power delta of +10 KW is thus altered by the predefined maximum power of generator 418b and decreased by 5 KW to +5 KW. The target power delta for consumer object 412e is then decreased to +5 KW by the predefined maximum power of generator 418b.

As a further example, as noted with respect to FIG. 4, consumer object 412e can be a cloud consumer object and a predetermined possible maximum power consumed by cloud consumer object 412e is taken into account when determining if the target power delta resulting from substep 306b for generator 418b violates the predefined maximum power of generator 418b. For example, if the possible maximum power consumed by cloud consumer object 412e is 150 KW, and the current power of cloud consumer object 412e is 140 KW, then a +10 KW power delta is set aside for cloud consumer object 412e and this +10 KW is added to the target power delta resulting from substep 306b to determine if generator 418b violates its predefined maximum power.

With respect to a predefined minimum power of a generator, this minimum power is also compared to the determined absolute target power for the generator resulting from the substep 306b. This absolute target power is the target power delta for the generator at the end of substep 306b plus the current power of the generator. In other words, the absolute target power is the current power of the generator plus the generator target power delta from the first power directive (i.e, generator target power delta from substep 306a), and any decrease of the generator target power delta resulting from the subsequent power directives (e.g., the second and third power directives) plus the current power of the generator.

Referring to the example shown in Table 10, if the current power of the generator 418a is 200 KW, and the predefined minimum power of generator 418a is 190 KW, the target power delta of cumulative −40 KW power delta resulting from substep 306b for consumer objects 412a to 412d powered by generator 418a would result in an absolute target power of 160 KW violating this predefined minimum power. The target power delta of −40 KW is thus altered by the predefined minimum power of generator 418a and increased by 30 KW to −10 KW. Using the utility values shown in Table 9 for the consumer objects 412a to 412d associated with generator 418a, this increase of 30 KW is thus allocated to consumer object 412d having the highest utility value, increasing the target power delta of consumer object 412d to +30 KW.

With respect to a predefined maximum ramp up rate of a generator, this maximum ramp up rate is compared to the determined target power delta for the generator resulting from the substep 306b. The determined target power delta for the generator resulting from the substep 306b is the generator target power delta from the first power directive (i.e, generator target power delta from substep 306a), and any decrease of the generator target power delta resulting from the subsequent power directives (e.g., the second and third power directives).

Referring to the example shown in Table 11, the target power delta resulting from substep 306b is +10 KW during a predefined time period for generator 418b, and if the predefined maximum ramp up rate of generator 418b is +55 KW during the same predefined time period, the target power delta of +10 KW resulting from substep 306b is not altered by the predefined maximum ramp up rate of generator 418b because it does not violate the predefined maximum ramp up rate. However, if the target power delta resulting from substep 306b is +75 KW during a predefined time period for generator 418b, it would violate +55 KW maximum ramp up rate, and the target power delta for generator 418b, and the corresponding target power delta of consumer object 412e, is reduced by −20 KW. If generator 418b provided power to multiple consumer objects, the consumer object with the lowest utility is reduced by −20 KW if the consumer object with the lowest utility has a current power of at least 20 KW. As noted above, if the consumer object with the lowest utility has a current power of less than 20 KW, a portion of the −20 KW power delta is distributed to the consumer object with the lowest utility and a portion of the −20 KW power delta is distributed to the consumer object with the second lowest utility.

With respect to a predefined minimum ramp down rate of a generator, this minimum ramp down rate is compared to the determined target power delta for the generator resulting from the substep 306b. The determined target power delta for the generator resulting from the substep 306b is the generator target power delta from the first power directive (i.e, generator target power delta from substep 306a), and any decrease of the generator target power delta resulting from the subsequent power directives (e.g., the second and third power directives).

Referring to the example shown in Table 10, the cumulative target power delta resulting from substep 306b is −40 KW during the predefined time period for consumer objects 412a to 412d associated with generator 418a, and if the predefined minimum ramp down rate of generator 418a is −60 KW during the same predefined time period, the target power delta of −40 KW resulting from substep 306b is not altered by the predefined minimum ramp down rate of generator 418a because it does not violate the minimum ramp down rate. However, if the target power delta resulting from substep 306b is −75 KW during a predefined time period for generator 418a, it would violate −60 KW minimum ramp down rate. Because the power delta required by the predefined minimum ramp down rate of generator 418a is a positive power delta, it is allocated to the highest utility consumer object, which in Table 10 is consumer object 412d. As consumer object 412d had a target power delta of 0 KW at the end of substep 306b, it would be increased from 0 KW to +15 KW.

If the predefined minimum power of generator 418a is taken into account as noted above, and the power of consumer object 412d was already increased from 0 KW to +30 KW, the cumulative target power delta for consumer objects 412a to 412d associated with generator 418a is above the predefined minimum ramp down rate of generator 418a, and there is no further increase of the cumulative target power delta for consumer objects 412a to 412d associated with generator 418a based on the predefined minimum ramp down rate of generator 418a.

In a next substep 306d, the target power deltas resulting from substep 306c for each of the consumer objects is sent for distribution within the consumer objects. More specifically, the target power deltas resulting from substep 306c for each of the consumer objects is sent from a respective power control module (e.g., the lead power control module 114d or 124d) to the respective container orchestrator (e.g., container orchestrator 114c, 124c). Referring to the example in FIG. 4, this can include sending the power delta for consumer objects 412a, 412b to the container orchestrator of container 414a, sending the power delta for consumer object 412c to the container orchestrator of container 414b, sending the power delta for consumer object 412d to the container orchestrator of container 414c and sending the power delta for consumer object 412e to the container orchestrator of container 414d.

In a next substep 306e, target power deltas in the modeled power distribution are distributed to the computing units of each group, i.e., each consumer object, by allocating the power deltas to the computing units of each of a plurality of groups of computing units based on a hierarchy of each of the computing units within the respective group.

For example, this distribution within the groups can include distributing the target power delta for consumer object 412a to the computing units represented by consumer object 412a based on the hierarchy of each of the computing units represented by consumer object 412a and distributing the target power delta for consumer object 412b to the computing units represented by consumer object 412b based on the hierarchy of each of the computing units represented by consumer object 412b. More specifically, this distribution within the groups includes retrieving the hierarchy ordering the computing units of a first group based on a specified utility of each of the computing units within the first group, and allocating a power delta distributed by the modeled power distribution to the computing units of the first group based on the hierarchy. Referring to consumer object 412a, this can include retrieving the hierarchy ordering the computing units of consumer object 412a based on a specified utility of each of the computing units of consumer object 412a, and allocating a power delta distributed by the modeled power distribution resulting from substep 306c to the computing units of consumer object 412a based on the hierarchy.

As discussed further above, a single power control module can be elected by a system orchestrator (e.g., system orchestrator 130c) for all of the container orchestrators on the same local area network, and the single power control module can send the target power deltas resulting from substep 306c to the respective container orchestrator (e.g., a respective container orchestrator in each of containers 414a to 414d). The container orchestrator can take the target power deltas for each of consumer objects 412a to 412e resulting from substep 306c and translate these target power deltas into workmode changes for the computing units represented by each consumer object 412a to 412e. The workmode changes can including turning on or turning off the computing units, or sending a command to enter a specific predefined power mode including for example lower power mode (e.g., less than 3 KW), normal power mode (e.g., 3 to 5 KW) or higher power mode (e.g., greater than 5 KW).

The translation of these target power deltas into workmode changes for the computing units represented by each consumer object 412a to 412e can include identifying, based on priority or hierarchy information associated with each of the DCUs, which DCUs should be subject to the target power delta for the consumer object. The priority or hierarchy information can be a utility value, which as noted above can represent a monetary value generated by the DCU in comparison to power consumption. If the power delta is a power decrease, one or more DCUs having the highest utility value can be selected for powering down, and thus the altering of the power state is changing the power from on to off. If the power delta is a power increase, one or more DCUs having the highest utility value can be selected for powering up, and thus the altering of the power state is changing the power from off to on. DCUs can also be provided with firmware that allows the amount of power drawn by each DCUs 112, 112 to be increased or decreased within a range of non-zero to 100%.

As noted above, the container orchestrators 114c, 124c can retrieve the hierarchy of DCUs 112, 122 under the control of the respective container orchestrator 114c, 124c (e.g., container orchestrator 114c controls DCUs 112, and container orchestrator 124c controls DCUs 112), and populate a data record with the hierarchy and the power currently being consumed by each DCU 112, 122. If for example the output power of the power generation module 231a or 231b need to be decreased, the container orchestrators 114c, 124c can select the lowest utility DCUs 112, 122 that can achieve the required power reduction for powering down. In particular, the container orchestrator 114c, 124c can for example start from the bottom of the hierarchy and select the lowest utility DCU for deactivation, then select the second utility priority DCU, and this process continues until the selected DCUs together have achieved the power delta resulting from substep 306c for the respective consumer object. Conversely, if more than one of the DCUs of the consumer object are currently turned off and not drawing power, then the hierarchy can be used to for selecting DCUs for activation to achieve the power delta resulting from substep 306c. Higher utility DCUs 112, 122 in the hierarchy are selected for activation before lower utility DCUs 112, 122.

For example, if the DCUs 112 are different models of cryptocurrency miners, the DCUs 112 can be prioritized by total hashrate per unit of energy consumed, which can include selecting DCUs 112 for powering based on the age of the DCU 112. If the five oldest DCUs 112 have an output equal to or greater than the power delta resulting from substep 306c, these five oldest DCUs 112 are selected for shutdown, and the remaining DCUs 112 continue to mine cryptocurrency and draw power from the respective power generation module 231a, 213b.

The container orchestrators 114c, 124c can retrieve the hierarchy of DCUs 112, 122 under the control of the respective container orchestrator 114c, 124c (e.g., container orchestrator 114 controls DCUs 112, and container orchestrator 124c controls DCUs 112), and populate a data record associate with the respective consumer object with the hierarchy and the power currently being consumed by each DCU 112, 122. If for example the output power of the power generation module 231a or 231b need to be decreased to achieve a negative target power delta, the container orchestrators 114c, 124c can then turn off the lowest utility DCUs 112, 122 that can achieve the negative target power delta.

Step 306 can include taking into consideration ambient temperatures at the offshore site, a temperature of a coolant used to cool the DCUs, and/or internal chip temperatures of the DCUs to allocate the target power deltas to consumer objects (e.g., in substep 306b) or to DCUs within each consumer object (e.g., in substep 306e). In some examples, DCUs can include firmware allowing the DCUs in the form of cryptocurrency miners to be operated in lower power mode (lower computing speed), a normal mode (normal computing speed) and a higher power mode (higher computing speed). Miners can operate in lower power modes at much higher ambient air temperatures than miners can operate in normal power modes and higher power modes. These lower power modes can allow system 103 to capture utility in high-temperature environments (Permian, MENA, Bakken hot weather) where miners would otherwise not operate. For substep 306b, upon a measurement that the ambient temperatures at the offshore site and/or internal temperatures of the miners are above a predetermined threshold, the modeled power distribution can account for all of the DCUs being be forced into lower power mode, then one or more consumer objects can be allocated a negative power delta if a further negative power delta is required by the power directives or by at least one device constraint (substep 306c). For substep 306e, instead of allocating a target power delta in the modeled power distribution by powering down individual miners of a consumer object, the target power delta can be allocated by operating a plurality of the miners in a lower power mode based on a measurement of the ambient temperatures at the offshore site and/or internal temperatures of the miners being above a predetermined threshold.

For example, if the DCUs in a container are cooled by water, a first temperature parameter to check lower deciding if a lower power mode should be implemented is inlet water temperature. The predetermined threshold for this parameter is approximately (+/−20%) 50° C.

A second temperature parameter to check is the maximum chip temp for each DCU. The predetermined threshold for this parameter is approximately (+/−20%) 105° C. If the ambient was getting too hot it is expected that maximum chip temperatures can reach the predetermined threshold for the second temperature parameter one DCU at a time. But if the first temperature parameter is the limiting value, many miners could reach the predetermined threshold almost simultaneously. Accordingly, DCUs are forced into lower power mode when either the predetermined threshold is reach for the first temperature parameter or the second temperature parameter.

Then when the ambient temperature cools down, the water, and the chips cool down also. The same two parameters are checked, against different criteria, to know when it is safe to go back to the higher power mode. Different thresholds are used to avoid unneccessary switching back and forth between modes. The first temperature parameter threshold for switching back to high temperature mode can be for example approximately (+/−20%) 45° C., and the second temperature parameter threshold for switching back to high temperature mode can be for example approximately (+/−20%) 100° C. DCUs are automatically shift from lower power mode back to high powermode only when the predetermined threshold is reached for both the first temperature parameter and the second temperature parameter. The first and second temperature parameter thresholds can also be set based on a weather forecast and temperature specifications of the DCUs.

Additionally, lower power mode also improves power-use efficiency, providing an improvement in utility during low-gas scenarios. A low gas scenario can be an engine pressure below a predetermined internal, such as 40 psi for an engine-type generator or below 320 psi for a turbine-type generator. A low gas scenario can also be a pressure at sensor 274 below a predetermined internal, such as 50 psi for an engine-type generator. For substep 306b, upon a measurement that a measurement, by a pressure sensor (e.g., by a pressure sensor 274) or flow meter, of a parameter of natural gas being supplied to the power generation module being is a predetermined threshold, the modeled power distribution can account for all of the DCUs being be forced into lower power mode, then one or more consumer objects can be allocated a negative power delta if a further negative power delta is required by the power directives or by at least one device constraint (substep 306c). For substep 306e, instead of allocating a target power delta by powering down individual miners of a consumer object, the target power delta can be allocated by operating a plurality of the miners in a lower power mode based on a measurement of a parameter of natural gas being supplied to the power generation module below a predetermined threshold.

Then step 308 of method 300 is performed, which is altering the power state of the DCUs 112 and/or 122 to achieve the optimal power consumption distribution model; and then a step 310 of periodically repeating steps 302 to 308.

### Computing Machines

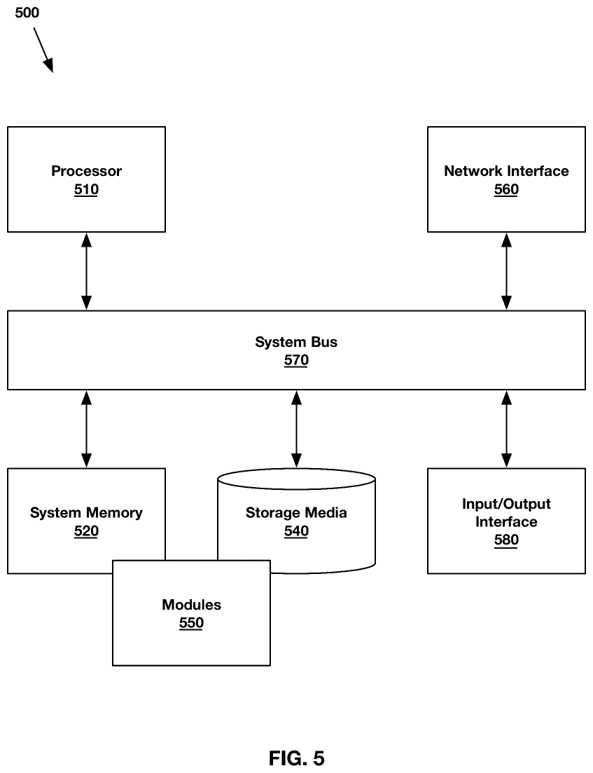

Referring to FIG. 5, a block diagram is provided illustrating an exemplary computing machine 500 and modules 550 in accordance with one or more embodiments presented herein.

The computing machine 500 may represent any of the various computing systems discussed herein, such as but not limited to, the DCUs 112, 122, components of control systems (FIG. 1A at 101, 114, 124), the client devices (FIG. 1A at 138) and/or the third-party systems. And the modules 550 may comprise one or more hardware or software elements configured to facilitate the computing machine 500 in performing the various methods and processing functions presented herein.

The computing machine 500 may comprise all kinds of apparatuses, devices, and machines for processing data, including but not limited to, a programmable processor, a computer, and/or multiple processors or computers. As shown, an exemplary computing machine 500 may include various internal and/or attached components, such as a processor 510, system bus 570, system memory 520, storage media 540, input/output interface 680, and network interface 560 for communicating with a network 530.

The computing machine 500 may be implemented as a conventional computer system, an embedded controller, a server, a laptop, a mobile device, a smartphone, a wearable device, a kiosk, customized machine, or any other hardware platform and/or combinations thereof. Moreover, a computing machine may be embedded in another device, such as but not limited to, a portable storage device. In some embodiments, the computing machine 500 may be a distributed system configured to function using multiple computing machines interconnected via a data network or system bus 570.

The processor 510 may be configured to execute code or instructions to perform the operations and functionality described herein, manage request flow and address mappings, and to perform calculations and generate commands. The processor 510 may be configured to monitor and control the operation of the components in the computing machine 500. The processor 510 may be a general-purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 510 may be a single processing unit, multiple processing units, a single processing core, multiple processing cores, special purpose processing cores, coprocessors, or any combination thereof. In addition to hardware, exemplary apparatuses may comprise code that creates an execution environment for the computer program (e.g., code that constitutes one or more of: processor firmware, a protocol stack, a database management system, an operating system, and a combination thereof). According to certain embodiments, the processor 510 and/or other components of the computing machine 500 may be a virtualized computing machine executing within one or more other computing machines.

The system memory 520 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 520 also may include volatile memories, such as random-access memory (“RAM”), static random-access memory (“SRAM”), dynamic random-access memory (“DRAM”), and synchronous dynamic random-access memory (“SDRAM”). Other types of RAM also may be used to implement the system memory. The system memory 520 may be implemented using a single memory module or multiple memory modules. While the system memory is depicted as being part of the computing machine 500, one skilled in the art will recognize that the system memory may be separate from the computing machine without departing from the scope of the subject technology. It should also be appreciated that the system memory may include, or operate in conjunction with, a non-volatile storage device such as the storage media 540.

The storage media 540 may store one or more operating systems, application programs and program modules such as module, data, or any other information. The storage media may be part of, or connected to, the computing machine 500. The storage media may also be part of one or more other computing machines that are in communication with the computing machine such as servers, database servers, cloud storage, network attached storage, and so forth.

The modules 550 may comprise one or more hardware or software elements configured to facilitate the computing machine 500 with performing the various methods and processing functions presented herein. The modules 550 may include one or more sequences of instructions stored as software or firmware in association with the system memory 520, the storage media 540, or both. The storage media 540 may therefore represent examples of machine or computer readable media on which instructions or code may be stored for execution by the processor. Machine or computer readable media may generally refer to any medium or media used to provide instructions to the processor. Such machine or computer readable media associated with the modules may comprise a computer software product. It should be appreciated that a computer software product comprising the modules may also be associated with one or more processes or methods for delivering the module to the computing machine 500 via the network, any signal-bearing medium, or any other communication or delivery technology. The modules 550 may also comprise hardware circuits or information for configuring hardware circuits such as microcode or configuration information for an FPGA or other PLD.

The input/output (“I/O”) interface 680 may be configured to couple to one or more external devices, to receive data from the one or more external devices, and to send data to the one or more external devices. Such external devices along with the various internal devices may also be known as peripheral devices. The I/O interface 580 may include both electrical and physical connections for operably coupling the various peripheral devices to the computing machine 500 or the processor 510. The I/O interface 580 may be configured to communicate data, addresses, and control signals between the peripheral devices, the computing machine, or the processor. The I/O interface 580 may be configured to implement only one interface or bus technology. Alternatively, the I/O interface may be configured to implement multiple interfaces or bus technologies. The I/O interface may be configured as part of, all of, or to operate in conjunction with, the system bus 570. The I/O interface 580 may include one or more buffers for buffering transmissions between one or more external devices, internal devices, the computing machine 500, or the processor 510.

The I/O interface 580 may couple the computing machine 500 to various input devices to receive input from a user in any form. Moreover, the I/O interface 580 may couple the computing machine 500 to various output devices such that feedback may be provided to a user via any form of sensory feedback (e.g., visual, auditory or tactile).

Embodiments of the subject matter described in this specification can be implemented in a computing machine 500 that includes one or more of the following components: a backend component (e.g., a data server); a middleware component (e.g., an application server); a frontend component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network. Accordingly, the computing machine 500 may operate in a networked environment using logical connections through the network interface 560 to one or more other systems or computing machines across a network.

The processor 510 may be connected to the other elements of the computing machine 500 or the various peripherals discussed herein through the system bus 570. It should be appreciated that the system bus 570 may be within the processor, outside the processor, or both. According to some embodiments, any of the processor 510, the other elements of the computing machine 500, or the various peripherals discussed herein may be integrated into a single device such as a system on chip (“SOC”), system on package (“SOP”), or ASIC device.

In the preceding specification, the present disclosure has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

### Cooling System

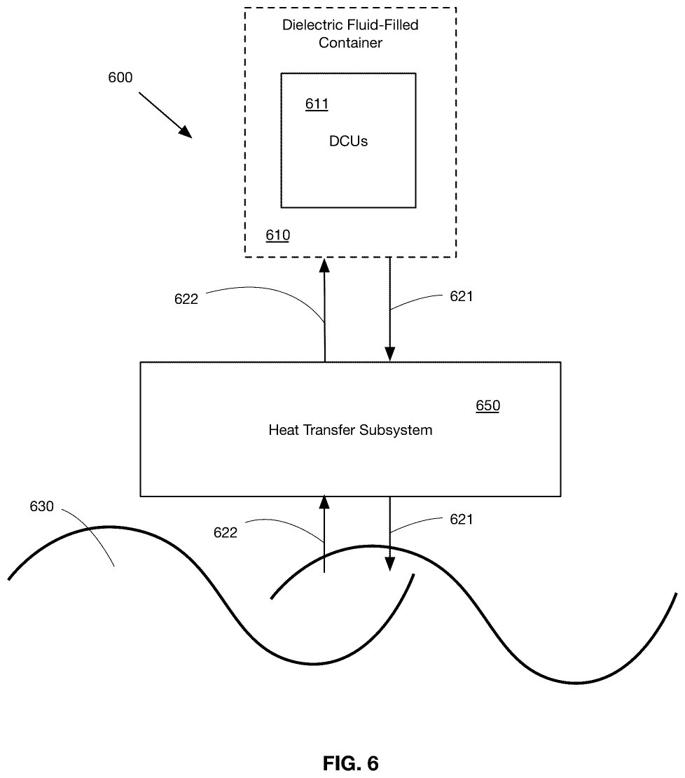

As shown in FIG. 6, an immersion cooling system 600 may be employed to cool the DCUs. Generally, immersion cooling utilizes a dielectric fluid that cools the computing hardware while also being non-conductive to electricity. This fluid is highly stable with low viscosity, which allows it to be easily circulated with pumps and piping. Further, the fluid is minimally volatile and nonflammable.

Immersion cooling of computing hardware not only enables the highly efficient liquid-liquid heat exchange technology articulated below, but also protects valuable computing hardware from salty sea air, which may be caustic or corrosive in an air-cooled application.

In one embodiment, a liquid-to-liquid cooling system (“LLCS”) may be employed. Generally, LLCS is adapted to allow the hot working fluid leaving an immersion cooling container to exchange its heat with cold sea water, cooling the working fluid in the process. The cooled working fluid is then returned through a closed-loop piping system to cool the immersion cooling container again before repeating this cycle.

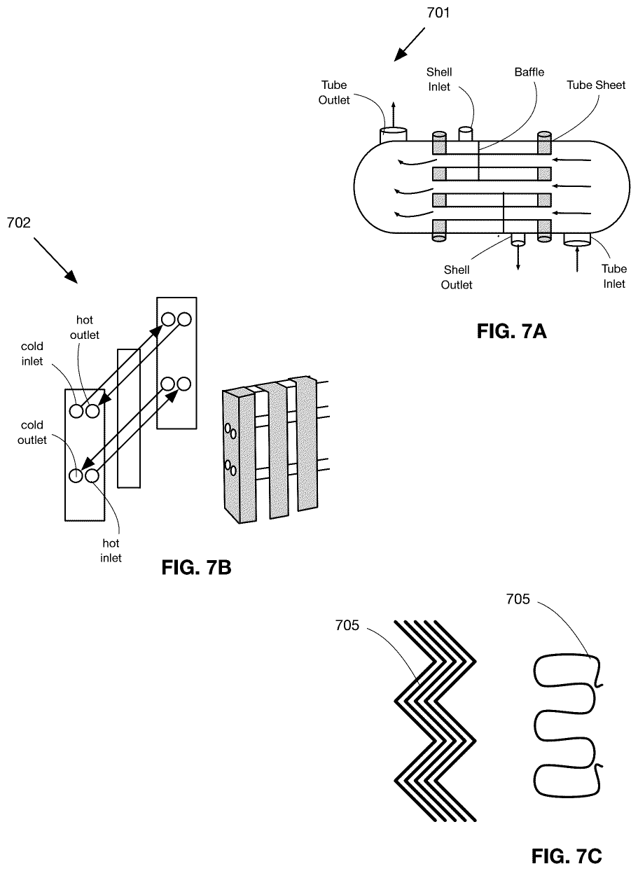

Generally, heat transfer may be accomplished through a heat transfer subsystem comprising one or more heat exchangers, such as shell-and-tube heat exchangers (FIG. 7A), plate-type heat exchangers (FIG. 7B), or routing pipes containing warm working fluid outside the hull of the vessel to directly contact cool sea water (FIG. 7C).

As shown in FIG. 7C, radiative piping may be designed to increase surface area and exposure time through a series of switchbacks or “zig-zags” that extends the fluid's travel path through cold sea water. The efficiency benefits of liquid-liquid heat exchange are tremendous compared to air-cooling, particularly in the case of a virtually unlimited heat sink such as the ocean.

A desalination unit can be provided upstream of the inlet of the heat exchanger to remove salt from the water entering into the heat exchanger and minimize corrosion of the interior of the heat exchanger.

### Communication System

In certain embodiments, each MDC (and any electronic components contained therein, e.g., DCUs) may be in communication with a communication system 132. For example, a MDC may be in direct communication with the communication system 132 via a wired connection. As another example, the DCUs may be in indirect communication with the communication system 132 via a network 134.

In one embodiment, the communication system 132 may comprise one or more data satellite antennas optimized for conditions at sea. The antennas may be mounted to nautical gimbals in order to maintain alignment with satellites. Alternatively, portable antennas (e.g., KYMETA antennas) may be employed to achieve up to 100 MBps connectivity from geosynchronous or low-earth orbit (“LEO”) satellites from a non-stationary base station. Secondary communication systems including cellular, radio, microwave or millimeter wave may also be deployed.

A typical configuration is for two antennas to serve a single mobile data center in order to provide reliability and redundancy; however, a single antenna may be sufficient depending on bandwidth requirements and total DCU count. Alternatively, many (e.g., three or more) antennas may be employed, and communications cables may extend from the MDC to other nearby MDCs to provide a centralized communications solution.

The one or more data satellite antennas of the communication system 132 may be specified for continuous outdoor use, and may be installed using robust mounting hardware to ensure alignment even during heavy wind. Antenna modems may be housed inside a MDC for warmth, security and weatherproofing, and such modems may be connected to the power system of the MDC.

In one embodiment, the communication system 132 may provide an internal network that includes automatic load-balancing functionality such that bandwidth is allocated proportionately among all active antennas. In such embodiment, if a single antenna fails, the lost bandwidth is automatically redistributed among all functioning antennas. This is an important reliability feature for oilfield operations, where equipment failures due to storms are possible.

In another embodiment, the antennas and satellite internet systems of the communication system 132 may be specified based on the needs of the power consumption system 103, with specific attention paid to bandwidth and latency requirements. For lower bandwidth applications such as certain blockchain processing, cryptocurrency mining and/or long-term bulk data processing jobs, high-orbit satellite connectivity ranging from 10 MB/s to 100 MB/s may be specified. For higher bandwidth or low latency requirements such as artificial intelligence model training, iterative dataset download and boundary spamming projects, visual processing such as images or videos, natural language processing, iterative protein folding simulation jobs, videogaming, or any other high capacity data streaming or rapid communication jobs, low-orbit satellites may be specified to provide significantly increased speeds and reduced latency.

In any event, the communication system 132 may provide a network 134 to which various components of the system 100 may be connected. The network 134 may include wide area networks (“WAN”), local area networks (“LAN”), intranets, the Internet, wireless access networks, wired networks, mobile networks, telephone networks, optical networks, or combinations thereof. The network 134 may be packet switched, circuit switched, of any topology, and may use any communication protocol. Communication links within the network 134 may involve various digital or an analog communication media such as fiber optic cables, free-space optics, waveguides, electrical conductors, wireless links, antennas, radio-frequency communications, and so forth.

### Gas Processing System

In one embodiment, the system may comprise a natural gas processing system adapted to receive a raw natural gas stream from one or more offshore platforms. The natural gas processing system is generally adapted to convert the received raw natural gas into a fuel gas stream that may be introduced to an electrical power generation system.

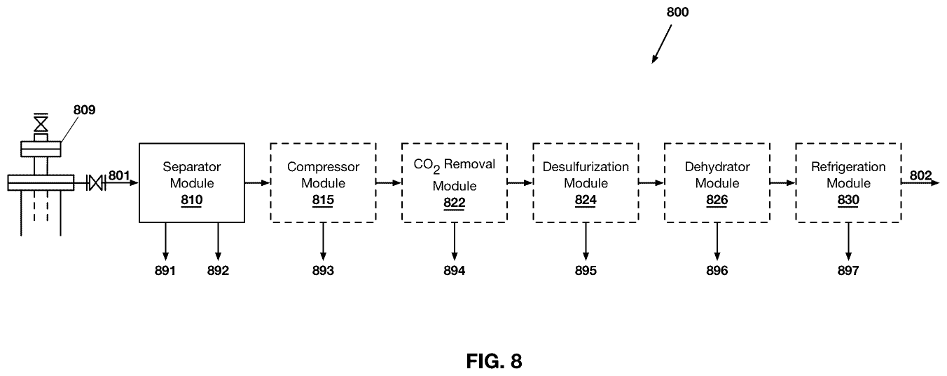

Referring to FIG. 8, an exemplary natural gas processing system 800 according to an embodiment is illustrated. As shown, the system 800 may comprise a separator module 810 and various optional components, such as a compressor module 815, a CO2 removal module 822, a desulfurization module 824, a dehydrator module 826 and/or a refrigerator module 830.

Generally, the natural gas processing system 800 is adapted to convert a raw natural gas stream 801 received from one or more offshore platforms 809 into a fuel gas stream 802 and, optionally, various secondary streams. As used herein, the term “raw natural gas” or “raw gas” means unprocessed natural gas released during oil and/or gas production. Raw natural gas 801 may also be referred to as “associated gas,” “flare gas,” “produced gas,” and/or “stranded gas.”

Raw natural gas 801 at a wellhead 809 is commonly a mixture of hydrocarbons, including methane (CH4), ethane (C2H6), propane (C3H8), butane (C4H10), pentane (C5H12), hexane (C6H14) and higher hydrocarbons. The raw natural gas 801 also contains other compounds such as water vapor (H2O), hydrogen sulfide (H2S), carbon dioxide (CO2), oxygen (O2), and nitrogen (N2).

As used herein, the term “fuel gas” 902 refers to a natural gas stream that has been processed by a natural gas processing system 800 such that it may be used by an electrical power generation system (e.g., FIG. 1A at 130) to generate electrical power for a distributed computing system (FIG. 1A at 140). It will be appreciated that the properties of the fuel gas 802 produced by the natural gas processing system 800 may vary depending on the raw natural gas and requirements of the employed electrical power generation system.

Nevertheless, the fuel gas 802 will typically comprise a heat value of at least about 1,000 Btu/scf and a methane content of at least about 80%. In some embodiments, the fuel gas 802 may be processed to contain less than about 1% pentane and higher hydrocarbons (C5+) components. Moreover, such fuel gas 802 may be optionally be processed to contain less than about 5% propane and higher hydrocarbons (C3+) components.

In some embodiments, the produced fuel gas 802 may be substantially free of particulate solids and liquid water to prevent erosion, corrosion or other damage to equipment. Moreover, the fuel gas may be dehydrated of water vapor sufficiently to prevent the formation of hydrates during downstream processing. And, in certain embodiments, the produced fuel gas 802 may contain no more than trace amounts of components such as H2S, CO2, and N2.

As shown, the raw natural gas 801 received from the platform 809 may first be introduced to a separator module 810 such that liquids (e.g., oil 891 and/or water 892) may be separated and removed therefrom. Generally, the separator module 810 may comprise at least one multi-phase separator, such as a 2-phase separator (separating liquids and gas), or a 3-phase separator (separating oil, water, and gas),

In one particular embodiment, the separator module 810 comprises a 3-phase separator. An exemplary 3-phase separator may comprise a vessel having an inlet to receive the raw natural gas 801, an outlet through which free gas exits the vessel, an outlet through which water exits the vessel, and an outlet through which oil exits the vessel. Upon entering the vessel, the raw gas 801 may encounter an inlet deflector, which causes initial separation of gas from a liquid mixture of oil and water. The free gas may then rise within the vessel, while the heavier liquid mixture descends therewithin. And, optionally, a divertor may be employed within the vessel to redirect flow of the liquid mixture and to allow it to settle more readily within the vessel.

Once separated from the liquid, the free gas may flow through a mist extractor that removes any entrained liquids remaining in the gas. The resulting gas stream then flows out of the top of the separator vessel, through the gas outlet.

As the liquid mixture settles within the separator vessel, the oil separates from the water and rises out of solution. In one embodiment, a weir plate may be employed to allow the oil to pour into an oil chamber or bucket, while preventing the water from entering the chamber. Additionally, the separator may include a metal protector plate to block any splashing liquid from entering the gas outlet.

Generally, the recovered oil 891 can be directed to an oil storage tank or may be transported for sale via ship or subsea pipeline. And the water 892 may be sent to a water storage tank, treated on-site, disposed of, and/or transported to a wastewater treatment facility or other reclamation zone.

In one embodiment, the separator module 810 may comprise, or otherwise be placed in communication with, various monitoring and/or control equipment. Such equipment may be adapted to measure, determine and/or control various operating parameters at any number of locations throughout the separator module 810. As discussed above, such equipment may be in communication with a remote MC system (e.g., via a network) to allow for both (1) remote monitoring and control of the separator module 810 by any number of operators and (2) automatic control thereof.

As an example, the separator module 810 may comprise any number of pressure monitors, flow meters, regulators and/or control valves to monitor/control gas and/or liquid processing parameters (e.g., inlet/outlet pressure, inlet/outlet flow, level, etc.). Such equipment may be located within one or more vessels, on one or more inlets and/or on one or more outlets of the separator module 810.

It will be appreciated that the separator module 810 may further comprise any number of safety valves adapted to direct flow to a safe and contained area upon overpressurization of the vessel. In one embodiment, the separator module may comply with ASME VIII, Division 1 and NACE MR-0175 for H2S environments. Additionally or alternatively, the separator module may comprise a skid designed to SEPCO OPS055 and/or API RP2A standards.

In certain embodiments, the separator module 810 may further comprise a heater-treater component located upstream of the multi-phase separator or integral therewith. Generally, the heater-treater may comprises a pressurized vessel, or a series of pressurized vessels, in which a bottom-mounted, heat source is operated. During operation, the heater-treater heats the raw natural gas 801 received from the platform 809 by means of direct contact with the heat source and the ensuing temperature increase reduces molecular attraction between oil and water molecules contained therein. Accordingly, when the heated raw natural gas is passed to the multi-phase separator, water droplets may settle out of the liquid more rapidly.

In one embodiment, the gas stream produced by the separator module 810 may be of a sufficient quality to be directly utilized as fuel gas 802 for a power generation module of the electrical power generation system. In such cases, the resulting gas stream 802 may not be introduced to any of the optional processing modules shown in FIG. 8; rather, it may be transferred directly to an electrical power generation module. It will be appreciated that, although the illustrated optional processing modules are not employed in this embodiment, the fuel gas 802 may be aggregated (e.g., in a field gathering pipeline) before being introduced to the electrical power generation module. Additionally or alternatively, conventional valves and/or compressors may be employed upstream of the electrical power generation module to regulate the pressure of the fuel gas 802.

In other embodiments, the gas stream produced by the separator module 810 may require additional processing upstream of the power generation module. In such cases, the natural gas processing system 800 may comprise one or more of: a compressor module 815, a CO2 removal module 822, a desulfurization module 824, a dehydrator module 826 and/or a refrigeration module 830.

Generally, a compressor module 815 may be employed to increase the pressure of the gas stream from an initial pressure of from about 15 psi to about 50 psi, to a final pressure of from about 150 psi to about 350 psi. Such pressure increase may be desired or required when a refrigeration module 830 is employed (discussed below) and/or in cases where the fuel gas 802 is to be introduced to a power generation module comprising a turbine.

As a result of the pressure increase, the compressor module 815 may also remove heavy natural gas liquids (“NGLs”) stream 993 comprising pentane and higher hydrocarbons (C5+) from the natural gas. To that end, the compressor module 815 may comprise any number of individual compressor units operating to raise and lower the pressure of the received gas stream, during any number of compression stages, such that the NGLs 893 contained therein may be liquified and removed. The resulting NGLs stream 893 may exit the compressor module 815 and may be stored in a storage tank and/or transported for sale via ship or subsea pipeline.

Accordingly, the compressor module 815 may produce a resulting gas stream comprising methane, ethane, propane, and butane, wherein the gas stream is substantially free of pentane and higher hydrocarbons (C5+). That is, the resulting compressed gas stream will typically comprise less than about 1% C5+ hydrocarbons, such that the stream comprises a heat content of from about 1,200 Btu/scf to about 1,500 Btu/scf.

In one embodiment, the compressor module 815 may comprise any number of individual compressor units. The compressor units may be driven by either conventional piston engines or natural gas turbines, and such units are typically fueled by a portion of the natural gas (although some or all of the units may be electrically powered if required). The compressor units typically operate in parallel, although some or all of the compressor units may be operated in stages (serially) as desired or required.

As the gas is compressed, heat is generated and must be dissipated to cool the gas stream before leaving the compressor module. Accordingly, the compressor module 815 may comprise an aerial cooler system to dissipate excess heat (e.g., an “after cooler”). Additionally, the heat generated by operation of the individual compressor units may be dissipated via a sealed coolant system.

The compressor module 815 may comprise, or otherwise be placed in communication with, various monitoring and/or control equipment adapted to monitor and/or control operating parameters (e.g., gas flow and/or pressure) across all compressor units. Such equipment may be in communication with the remote MC system (e.g., via a network) to allow for remote monitoring and control of the compressor module 815 by any number of operators and/or for automatic control thereof.

In certain embodiments, the natural gas processing system 800 may include a CO2 removal module 822 to remove CO2 294 from the gas stream. Generally, the CO2 removal module 822 will be employed, as required, to meet pipeline specifications. For example, the CO2 removal module 822 may be employed to reduce CO2 content in the gas stream to less than about 1% CO2.

In one embodiment, the CO2 removal module 822 may comprise one or more membranes, such as a spiral-wound cellulose acetate membrane. Generally, the membrane operates on the principle of selective permeation, where components with higher permeation rates (e.g., CO2) permeate through a membrane faster than those with lower permeation rates (e.g., methane, ethane and heavier hydrocarbons). Accordingly, the gas feed stream may be separated into a hydrocarbon-rich (residual) stream on the exterior of the membrane fiber and a CO2-rich (permeate) stream on the interior of the membrane fiber.

It will be appreciated that the CO2 removal module 822 may be adaptable to various gas volumes, CO2 concentrations, and/or fuel gas specifications. Moreover, operational parameters of the CO2 removal module, such as pressure difference between the feed gas and permeate gas and/or concentration of the permeating component, may be monitored and/or controlled via various equipment in communication with the remote MC system.

In another embodiment, the CO2 removal module 822 may comprise an amine sorbent system. As known in the art, such systems are adapted to absorb CO2 and then desorb the CO2 to atmosphere.

In one embodiment, the natural gas processing system 800 may include a desulfurization module 824 adapted to remove sulfur 895 from the gas stream. Generally, sulfur exists in natural gas as hydrogen sulfide (H2S), and the natural gas will typically require desulfurization when its H2S content exceeds about 0.01 lbs/Mscf. It will be appreciated that gas containing high levels of H2S (i.e., “sour gas”) is undesirable because it is both corrosive to equipment and dangerous to breathe.

The desulfurization module 824 may employ various technologies to “sweeten,” or remove sulfur from, sour gas. In one embodiment, the desulfurization module 824 may employ dry sorbents to capture sulfur gases in solid form (e.g., as sulfates or sulfites). In one such embodiment, a fine sorbent may be injected into the feed gas and the resulting sulfur-containing solids 895 may be collected. Exemplary dry sorbents that may be employed include, but are not limited to, calcium oxide, magnesium oxide, and sodium carbonate.

In an alternative embodiment, the desulfurization module 824 may comprise a wet scrubber subsystem, such as venturi, packed-column, or tray-type systems. In this embodiment, the feed gas may be contacted with a scrubbing solution or slurry to absorb the H2S and convert it to mercaptans, which are then drained from the spent bed in liquid form.

In yet another embodiment, the desulfurization module 824 may employ amine solutions to remove H2S. During this process, the feed gas is run through a tower containing an amine solution that absorbs sulfur. Exemplary amine solutions may include, but are not limited to, monoethanolamine (“MEA”) and diethanolamine (“DEA”). In one such embodiment, the amine solution may be regenerated (i.e., the absorbed sulfur may be removed) and reused.

In certain embodiments, the sulfur-containing discharge 895 may be discarded. However, in other embodiments, the sulfur may be reduced to its elemental form via further processing and then sold. One exemplary process employed to recover sulfur is known as the “Claus process” and involves using thermal and catalytic reactions to extract the elemental sulfur from the hydrogen sulfide solution.

It will be appreciated that, no matter which of the above technologies is employed by the desulfurization module 824, a resulting gas stream may be produced that is virtually free of sulfur compounds. That is, the resulting gas stream may comprise a sulfur content of less than about 0.01 lbs/Mscf.

The natural gas processing system 800 may additionally or alternatively comprise a dehydrator module 826 adapted to remove water 896 from the gas stream. Generally, the dehydrator module 826 may be employed to reduce the moisture content of the gas stream to about 7 lbs/Mscf or less. This mitigates the risk of damage to pipes and process equipment from blocked flow and corrosion.

In one embodiment, the dehydrator module 826 may comprise any number of dryer beds including one or more desiccants. Exemplary desiccants include, but are not limited to: activated charcoal/carbon, alumina, calcium oxide, calcium chloride, calcium sulfate, silica, silica alumina, molecular sieves (e.g., zeolites), and/or montmorillonite clay. In one particular embodiment, desiccant materials may be present in a packed-bed configuration.

It will be appreciated that most desiccants have a limited adsorption capacity and must be replaced or regenerated at given service intervals. Accordingly, for continuous dehydration service, a multi-bed system may be employed where one or more beds are utilized while the others are being replaced/regenerated. The active bed(s) can then be switched in and out of service as required or desired.

In another embodiment, the dehydrator module 826 may comprise a Triethylene Glycol (“TEG”) system. This system contacts the wet gas with TEG, which absorbs the water from the wet gas stream to produce a rich TEG stream. The rich TEG stream is heated with a gas-fired heater and the water is driven off in the form of water vapor to atmosphere. The lean TEG stream may then be cooled and pumped back to contact the gas stream.

In other embodiments, the dehydrator module 826 may remove water through the use of additives, such as methanol or ethylene glycol, which may be sprayed into the natural gas stream to suppress the freezing point of liquid water. In yet other embodiments, dehydration may comprise a number of steps, including active dehydration, depressurization, regeneration, and repressurization.

In certain embodiments, the natural gas processing system 800 may include a refrigeration module 830 comprising one or more mechanical refrigeration units (“MRU”). Generally, the refrigeration module may be employed to cool natural gas in an effort to reduce the hydrocarbon dew point of the gas (e.g., to meet pipeline quality specifications) and/or to maximize NGLs recovery (e.g., to improve the overall monetary return of a natural gas stream).

In one embodiment, the refrigeration module 830 may be adapted to lower the temperature of the received gas stream to a target temperature, such that NGLs comprising propane and higher hydrocarbons (C3+) 997 may be separated therefrom. The target temperature may be selected to allow the NGLs stream 897 to be condensed (e.g., in a single column), without condensing substantial amounts of methane or ethane. Accordingly, the condensed NGLs stream 897 may be separated and transported for sale via ship or subsea pipeline; and the resulting fuel gas stream 802, which comprises mostly methane and ethane, may be transferred to the electrical power generation module.

In certain embodiments, the refrigeration module 830 may lower the temperature of the received gas stream via heat exchange with a low temperature fluid (i.e., a refrigerant). Exemplary refrigerants include, but are not limited to, propane, propylene (C3H6), n-butane, and/or ethylene (C2H4). It will be appreciated that other hydrocarbon and non-hydrocarbon refrigerants may additionally or alternatively be employed.

Generally, the refrigeration module 830 may cool the received gas stream to a target temperature of from about −10° F. to about −32° F., depending on the composition of the received gas stream. During cooling, the pressure may be adjusted to, or maintained at, from about 70 psi to about 510 psi.

In one particular embodiment, the refrigeration module 830 may comprise a cascade refrigerator that employs two or more refrigeration stages in series to achieve a lower temperature than is otherwise achievable in a single stage. For example, the refrigerator may cool the gas to a first temperature during a first stage (i.e., a “high stage”), and then cool the gas to a second temperature that is lower than the first temperature during a second stage (i.e., a “low stage”).

It will be appreciated that operational parameters of the refrigeration module 830 may be monitored and/or controlled across any number of refrigeration units via various equipment in communication with the remote MC system. Such operational parameters may include, but are not limited to, temperature and/or coolant recirculation rate.

It will be appreciated that many aspects of the system 800 depicted in FIG. 8 may be modified or altered to produce fuel gas 802 from raw natural gas 801 received from one or more wellheads 809 in an oil and gas reservoir. The illustrated system 800 is exemplary, and is intended to show broadly the relationship between the various aspects of the system.

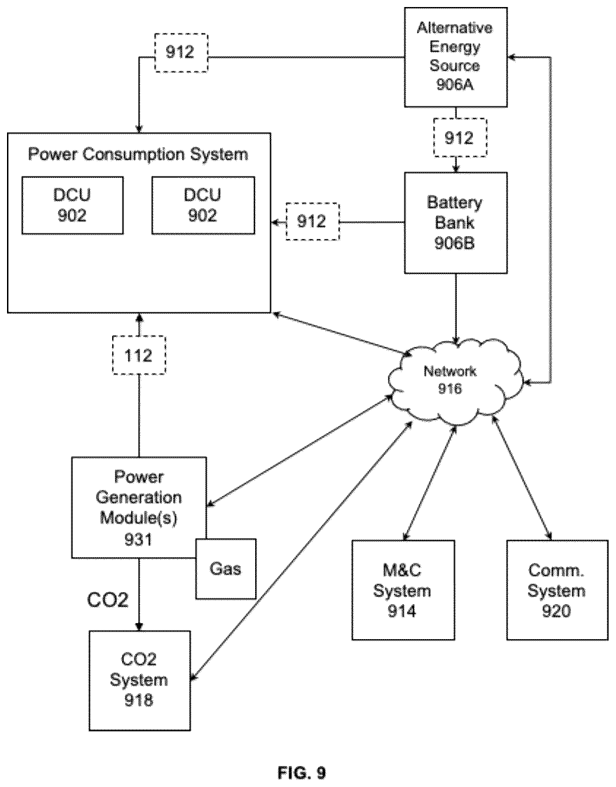

Referring to FIG. 9, an exemplary power management system 900 is illustrated. As shown, the system 900 may comprise: a power generation module(s) 931, an optional carbon capture system 918, one or more data centers 902, any number of cryptocurrency mining systems 910, a communication system 920, a Monitoring and control system 914 and a power switching system 912. As shown, the system 900 may comprise a communication system 920 that provides network 916 to which various components may be connected.

System with Backup Energy Sources

As shown, a power management system 900 can be on board one or more vessels 901 and may include one or more power generation modules 931 (which can the same as power generation module 231) at an offshore drilling site for powering DCUs 902 in a power consumption system configured in the same manner as power consumption system 103 in FIG. 1a, along with backup power sources in the form of an alternative energy source 906A and a battery bank 906B. The alternative energy source 906A may comprise at least one wind turbine on one or more vessels 901, at least one solar panel on one or more vessels 901 or a hydroelectric power device on one or more vessels 901. The hydroelectric power device can be a tidal turbine or a wave energy converter (WEC).

Alternative energy source 906A and a battery bank 906B can power the DCUs 902 when the one or more power generation modules 931 are inoperable or have a predicted power production that drops below a predetermined threshold. For example, a power generation module 931 can be identified as being inoperable by a monitoring and control system 914 when a motion sensor fixed to the power generation module 901 indicates that the movement of vessel 901, due to waves and/or tidal forces, exceeds a predetermined threshold.

The power management system 900 may further include a power switching system 912 configured to supply electricity to the DCUs 902 from either one or more power generation modules 931 or the alternative energy source 906A and/or battery bank 906B. The power switching system 912 may be in communication with a monitoring and control system 914, for example, via a network 916.

The power management system 900 may comprise a carbon capture system 918 configured to receive exhaust gas from power generation module(s) 931 and remove carbon therefrom. Generally, the carbon capture system 918 can advantageously capture and remove at least 75% of the carbon from the exhaust gas.

In one embodiment, the carbon capture system 918 can remove carbon dioxide from the exhaust gas using a solvent, which is then heated to separate the carbon molecules (e.g., as CO2). The CO2 stream may then be compressed and injected into a sequestration well near the system or may be routed to a dedicated CO2 pipeline. The solvent may be an amine solvent, for example monoethanolamine (MEA).

In another embodiment, the carbon capture system 918 may comprise one or more membranes, such as a spiral-wound cellulose acetate membrane. Generally, the membrane operates on the principle of selective permeation, where components with higher permeation rates (e.g., CO2) permeate through a membrane faster than those with lower permeation rates. Accordingly, a CO2-rich (permeate) stream may be separated from the exhaust stream.

It will be appreciated that the carbon capture system 918 may be adaptable to various gas volumes and CO2 concentrations. Moreover, operational parameters of the carbon capture system 918 may be monitored and/or controlled via various equipment in communication with the monitoring and control system 914 (e.g., via a network 916).

The power management system 900 also includes a monitoring and control system 914 configured to receive status inputs, including but not limited to, an operational status of each of the alternative energy source 906A and the battery bank 906B indicating an availability of electricity from each of the alternative energy source 906A and the battery bank 906B to power the DCUs 902. The status inputs may also include an operational cost of each of the alternative energy source 906A and the battery bank 906A indicating a price of electricity from each of the energy source 906A and the battery bank 906A.

Monitoring and control system 914 is also configured to output a control signal to the power switching system 912 to switch from the primary power sources 906A, 906B to power generation module(s) 931 to supply electricity to DCUs 902 based on the status inputs.

Monitoring and control system 914 is generally adapted to maintain processing conditions within acceptable operational constraints throughout the system. Such constraints may be determined by economic, practical, and/or safety requirements. The monitoring and control system 914 may handle high-level operational control goals, low-level PID loops, communication with both local and remote operators, and communication with both local and remote systems.

In one embodiment, the Monitoring and control system 914 may be in communication with various monitoring and control equipment, such as sensors and/or controllers, via the network 916. Such monitoring and control equipment may be in further communication with various components of the DCUs 902, power sources 906A, 906B, the power generation module(s) 931, and power switching system 912, such that the monitoring and control system 914 may remotely monitor and control operating parameters throughout the power management system 900.

Monitoring and control system 914 can receive various system metrics, including the required power for DCUs 902, the power availability from battery bank 906A, the power availability from alternative energy source 906A, generator metrics and gas metrics from power generation modules of the power generation module(s) 931, and a miner status for each of the DCUs that are cryptocurrency miners.

Generally, the monitoring and control system 914 is configured to direct the power switching system 912 to charge the battery bank 906B via power generated by alternative power sources 906A when module(s) 931 are producing sufficient power to power all of the DCUs. Monitoring and control system 914 is also configured to direct the power switching system 912 to power DCUs with power from sources 906A and/or 906B when module(s) 931 are incapable of powering DCUs because module(s) 931 are producing insufficient power or are determined to be or predicted to be inoperable.

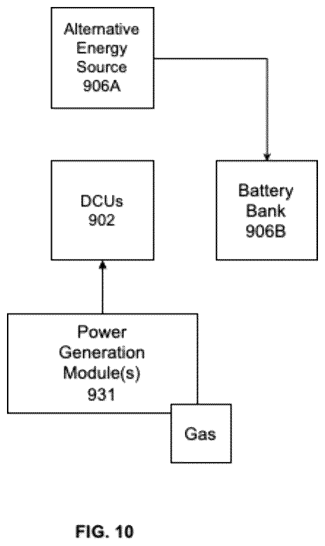

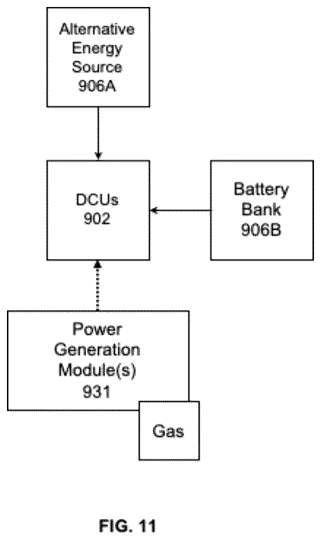

FIG. 10 shows the power management system 900 in a first condition where the monitoring and control system 914 directs the power switching system 912 to cause power generation module(s) 931 to power the DCUs 902 and the battery bank 906B is being charged by alternative energy source 906A.

FIG. 11 shows power management system 900 in another condition where the module(s) 931 are incapable of powering DCUs because module(s) 931 are producing insufficient power or are determined to be or predicted to be inoperable. In this condition, the monitoring and control system 914 directs the power switching system 912 to electrically couple the power sources 906A and/or 906B to the DCUs 902, and to direct the power sources 906A and/or 906B to power the DCUs 902. Upon a determination that module(s) 931 are inoperable, the monitoring and control system 914 can direct the power switching system 912 to electrically decouple the module(s) 931. Upon a determination that module(s) 931 are operable but are not producing sufficient power, the monitoring and control system 914 can direct the power switching system 912 to electrically couple the module(s) 931 and the power sources 906A and/or 906B to the DCUs 902.

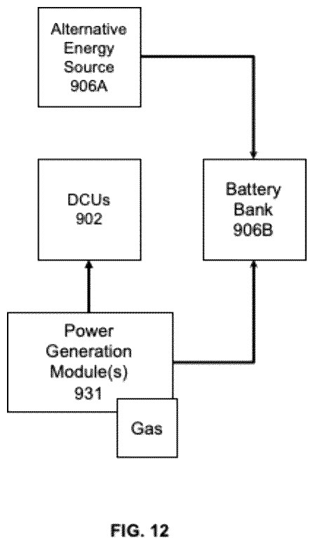

FIG. 12 shows power management system 900 in another condition where the module(s) 931 are producing more power than can be used by the DCUs 902. In the condition shown in FIG. 11, the monitoring and control system 914 directs the power switching system 912 to electrically decouple the power sources 906A, 906B from the DCUs 902, and to direct the power generation module(s) 931 to power the DCUs 902 and to charge the battery bank 906B, while the alternative energy source 906A also charges the battery bank 906B.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

It will be understood by those skilled in the art that the drawings are diagrammatic and that further items of equipment such as temperature sensors, pressure sensors, pressure relief valves, control valves, flow controllers, level controllers, holding tanks, storage tanks, and the like may be required in a commercial plant.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

All references, including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. An offshore flare mitigation system for powering distributed computing units by a fuel gas stream originating from an oil well below the ocean, the system comprising:
at least one vessel adapted for floating in the ocean;
a power production system comprising:
a power generation module adapted to:
receive the fuel gas stream comprising a fuel gas associated with a heat value of at least about 1,000 Btu/scf; and
consume the fuel gas stream to generate an electrical output;
a communications system adapted to provide a network; and
a power consumption system powered by the power production system, the power consumption system comprising:
a data center comprising:
an enclosure defining an interior space;
a plurality of the distributed computing units located within the interior space of the enclosure, each of the plurality of distributed computing units in communication with the network; and
a power distribution system in electrical communication the plurality of distributed computing units such that the power distribution system receives the electrical output and powers each of the plurality of distributed computing units,
wherein the at least one floating vessel carries the power production system, the communications system and the distributed computing system.

2. The offshore flare mitigation system as recited in claim 1, wherein the at least one vessel is a single vessel carrying the power production system, the communications system and the power consumption system.

3. The offshore flare mitigation system as recited in claim 1 wherein the at least one vessel includes a powership carrying the power production system and a data-processing vessel carrying the power consumption system.

4. The offshore flare mitigation system as recited in claim 1 wherein the at least one vessel includes a heat transfer system configured for pumping ocean water through heat transfer pipes.

5. The offshore flare mitigation system as recited in claim 4 wherein the heat transfer system includes dielectric fluid for transferring heat from the distributed computing units to the ocean water pumped through the heat transfer pipes.

6. The offshore flare mitigation system as recited in claim 1 wherein the power production system further comprises an electrical transformation module in electrical communication with the power generation module, the electrical transformation module adapted to:
receive the electrical output generated by the power generation module; and
transform the electrical output into a low-voltage electrical output associated with a low voltage that is lower than a voltage of the electrical output;

7. The offshore flare mitigation system as recited in claim 6 wherein the power distribution system is further in electrical communication with the electrical transformation module.

8. The offshore flare mitigation system as recited in claim 1 further comprising a control system for dynamic control of power consumption of the distributed computing units, the system comprising a processor, a memory, and a power control module and container orchestrator stored in the memory that, when executed by the processor, causes the processor to:
(a) receive metrics of the power production system and metrics of power consumption system;
(b) determine a target power production framework that includes a target power delta for each device associated with the power production system, the target power deltas being based on the metrics of power production system;
(c) determine an optimal power consumption distribution model for distributing the target power deltas of the target power production framework to the power consumers based on the target power production framework and the metrics of power consumption system;
(d) output signals for altering a power state (or workmode) of the power consumers to achieve the optimal power consumption distribution model; and
(e) periodically repeat (a) to (d) to update the power state of the power consumers based on changes of the metrics of the power production system and changes of metrics of the power consumption system.

9. A method of powering distributed computing units by a fuel gas stream originating from an underwater oil well below the ocean, the method comprising:
transporting, by at least one floating vessel, a power production system, a communications system and a power consumption system to an offshore drilling platform, the offshore drilling platform including a pipeline transporting natural gas originating from the underwater oil well;
receiving, by the power production system, a fuel gas stream from the pipeline comprising a fuel gas having a heat value of at least about 1,000 Btu/scf;
generating, by the power production system, from the fuel gas, a high-voltage electrical output associated with a first voltage;
transforming, by the electrical power generation system, the high-voltage electrical output into a low-voltage electrical output associated with a second voltage that is lower than the first voltage; and
powering, by the power production system, via the low-voltage electrical output, a plurality of distributed computing units of the power consumption system.

10. The method as recited in claim 9, further comprising:
(a) measuring and/or receiving metrics of the power production system and metrics of power consumption system;
(b) determining a target power production framework that includes a target power delta for each device associated with the power production system, the target power deltas being based on the metrics of power production system;
(c) determining an optimal power consumption distribution model for distributing the target power deltas of the target power production framework to the distributed computing units based on the target power production framework and the metrics of power consumption system;
(d) altering a power state of the distributed computing units to achieve the optimal power consumption distribution model; and
periodically repeating (a) to (d) to update the power state of the distributed computing units based on changes of the metrics of the power production system and changes of metrics of the power consumption system.

11. A method for powering a power consumption system onboard a vessel at an offshore drilling site, the power consumption system including a plurality of distributed computing units, the method comprising:
powering the distributed computing units by one or more power generation modules consuming natural gas originating from the offshore drilling site and continuously generating an electrical output;
powering, from an alternative energy source, a battery bank; and
upon determining that the one or more power generation modules are incapable of generating sufficient power for powering the distributed computing units, powering the distributed computing units at least in part by the alternative energy source and/or the battery bank.

12. The method as recited in claim 11, further comprising
upon determining that the one or more power generation modules are producing excess power greater than a maximum amount of power that can be consumed by the distributed computing units, directing such excess power to the battery bank for storage.
